(19) United States
(12) Patent Application Publication
(10) Pub. No.: US 2026/0288799 A1
(43) Pub. Date: Sep. 24, 2026

(54) SYSTEM

(71) Applicant: SoftBank Group Corp., Tokyo (JP)

(72) Inventor: Rino ABE, Tokyo (JP)

(73) Assignee: SoftBank Group Corp., Tokyo (JP)

(21) Appl. No.: 19/560,157

(22) Filed: Mar. 9, 2026

(30) Foreign Application Priority Data
Mar. 19, 2025 (JP) 2025-044550

(51) Int. Cl. G06F 16/3329; G06V 40/16

(52) U.S. Cl. CPC G06F 16/33295; G06V 40/176

(57) ABSTRACT

A system includes a processor that is configured to conduct, with a generative AI model, a conversation with a candidate regarding a predetermined theme and to analyze content of the conversation, analyze a statement, a facial expression, and a voice tone of the candidate by using an emotion recognition engine to estimate an emotion of the candidate, and generate a report that evaluates characteristics and emotional aspects of the candidate based on a result of the analysis of the conversation and a result of emotion recognition.

### CROSS-REFERENCE TO RELATED APPLICATION

This application is based on and claims priority under 35 USC 119 from Japanese Patent Application No. 2025-044550 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional recruitment processes, evaluation of candidates is largely based on document screening and limited human interviews. Document screening, such as review of résumés and application forms, often fails to reveal a candidate's actual behavioral characteristics, communication style, emotional tendencies, or suitability for specific roles. Human interviews, on the other hand, are time-consuming, subject to interviewer bias, and difficult to standardize across a large number of candidates. Furthermore, even when conversational AI is used to interact with candidates, conventional systems typically focus only on textual content and do not combine conversation analysis with multimodal emotion recognition, such as analysis of facial expressions and voice tone. As a result, it is difficult to obtain a comprehensive and objective assessment of both the characteristics and emotional aspects of candidates. In addition, there is insufficient support for automatically prompting a generative AI model to perform deeper analysis of portions that remain unclear after document screening, and for systematically reflecting the generative AI model's analytical results in a structured evaluation report.

### SUMMARY

In order to solve the above-described problems, the present invention provides a system comprising a processor, wherein the processor is configured to conduct, with a generative AI model, a conversation with a candidate regarding a predetermined theme and to analyze content of the conversation, analyze a statement, a facial expression, and a voice tone of the candidate by using an emotion recognition engine to estimate an emotion of the candidate, and generate a report that evaluates characteristics and emotional aspects of the candidate based on a result of the analysis of the conversation and a result of emotion recognition. The processor is further configured to generate and transmit, to the generative AI model, a prompt sentence for performing an additional analysis in order to further investigate portions that were unclear in a document screening, thereby enabling the generative AI model to provide deeper analytical insights beyond the information available from documents alone. Moreover, the processor is configured to evaluate a response of the candidate based on a prompt sentence so that the generative AI model analyzes characteristics of the candidate and reflects an analysis result in the report, whereby the system produces a standardized, comprehensive, and automatically generated evaluation of both candidate characteristics and emotional aspects, which assists recruiters in making more informed and unbiased hiring decisions.

The term “system” refers to an arrangement of hardware, software, and communication components, including at least one processor and associated memory and interfaces, configured to perform the functions described in the claims.

The term “processor” refers to any hardware processing unit or combination of units, such as a CPU, GPU, ASIC, FPGA, or microcontroller, capable of executing instructions to perform logical, arithmetic, control, or data-processing operations implementing the claimed functions.

The term “candidate” refers to a person who is being evaluated, for example as an applicant in a recruitment or selection process, and who participates in a conversation with the system.

The term “predetermined theme” refers to a topic or subject matter specified in advance by a system operator or configuration, such as teamwork, problem-solving, leadership, or motivation, which forms the basis for the conversation with the candidate.

The term “generative AI model” refers to an artificial intelligence model, such as a large language model or a multimodal generative model, that is capable of generating or analyzing natural language or other content in response to input prompts, and that participates in conversation with the candidate.

The term “conversation” refers to an interactive exchange of information between the candidate and the generative AI model, including sequences of questions, prompts, and responses, conducted through text, voice, video, or combinations thereof.

The term “content of the conversation” refers to information contained in the conversation, including the semantic meaning, linguistic structure, sequence, and context of utterances exchanged between the candidate and the generative AI model.

The term “statement” refers to verbal or textual expressions produced by the candidate during the conversation, including sentences, phrases, or utterances that convey information, opinions, or emotions.

The term “facial expression” refers to visual features of the candidate's face, such as movements or positions of eyes, eyebrows, mouth, and other facial muscles, that can be captured by an imaging device and analyzed for emotional indicators.

The term “voice tone” refers to acoustic characteristics of the candidate's spoken voice, including pitch, volume, tempo, intonation, timbre, and other prosodic features, which can be analyzed to infer emotional states or attitudes.

The term “emotion recognition engine” refers to a software and/or hardware component that processes input data, such as facial images, video streams, or audio signals, to detect or estimate emotional states of the candidate using rule-based or machine-learning techniques.

The term “emotion” refers to an estimated affective state of the candidate, such as happiness, sadness, anger, fear, surprise, anxiety, calmness, or other emotional categories or dimensions inferred from conversation content and multimodal signals.

The term “analysis of the conversation” refers to processing operations performed on the content of the conversation, including natural language understanding, sentiment analysis, extraction of behavioral indicators, and assessment of communication style or tendencies.

The term “emotion recognition result” refers to output data generated by the emotion recognition engine, including one or more estimated emotional states, associated confidence scores, or temporal patterns of emotions over the course of the conversation.

The term “report” refers to a structured output generated by the system, including textual, graphical, or data-structured information, that presents an evaluation of the candidate's characteristics and emotional aspects based on analysis and emotion recognition.

The term “characteristics of the candidate” refers to inferred personal attributes of the candidate, such as personality traits, behavioral tendencies, communication style, strengths, weaknesses, or suitability for particular roles or environments.

The term “emotional aspects of the candidate” refers to inferred features related to the candidate's emotional tendencies or patterns, such as typical emotional responses, emotional stability, sensitivity, or ways of expressing and managing emotions.

The term “document screening” refers to an evaluation process based primarily on written materials submitted by or collected about the candidate, such as résumés, curricula vitae, application forms, or prior assessment records, before or separate from the conversation.

The term “prompt sentence” refers to a text or structured instruction generated by the processor and provided to the generative AI model to specify a desired analysis, query, or operation, including prompts for additional or deeper analysis.

The term “additional analysis” refers to further processing or evaluation performed by the generative AI model, beyond initial analysis of the conversation, in order to clarify, refine, or expand understanding of the candidate, particularly regarding portions that were unclear from document screening.

The term “response of the candidate” refers to an answer, reply, or reaction provided by the candidate during the conversation, whether in textual, spoken, or other communicative form, to questions or prompts issued by the generative AI model or the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

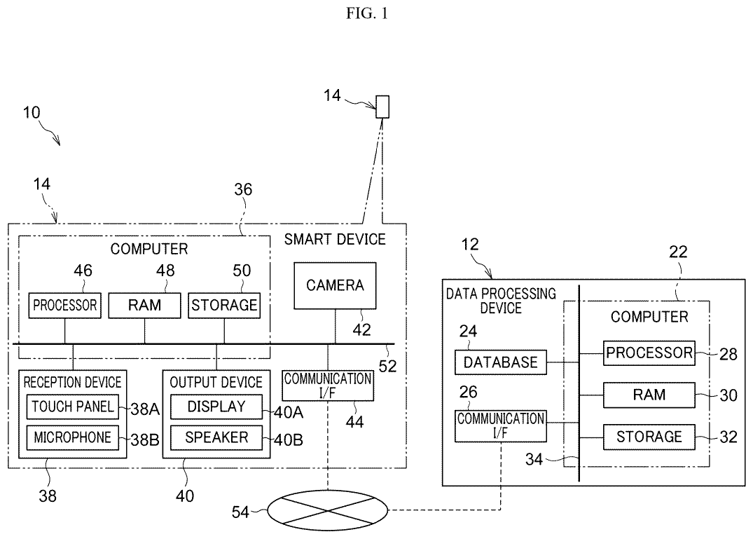

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

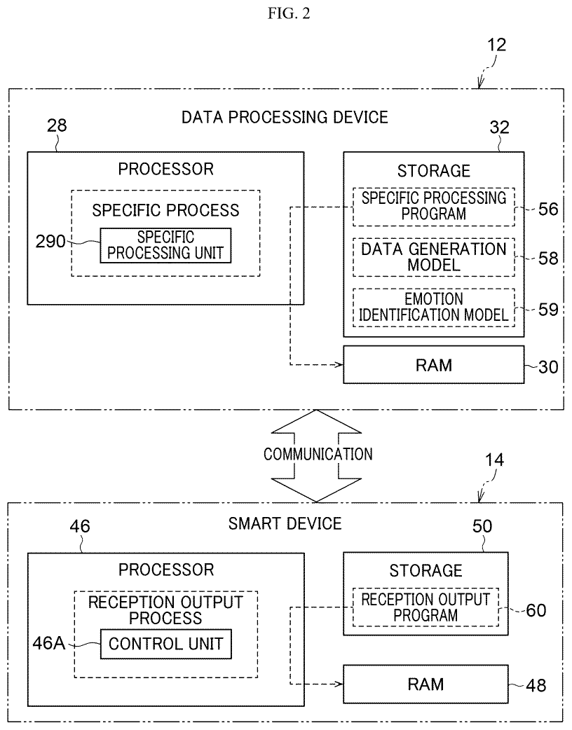

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional recruitment support systems, computer technology is mainly used to store and display static information such as resumes, test scores, and free-form text answers. Such systems generally rely on fixed questionnaires or simple keyword-based analysis and therefore do not fully exploit the capabilities of modern natural language processing and affective computing. As a result, server-side processing remains limited to straightforward data retrieval and rule-based scoring, which fails to capture a candidate's latent characteristics, complex thought patterns, and emotional tendencies present in natural conversational data.

Moreover, although dialog systems using generative AI models have recently emerged, these systems are typically designed for generic question-and-answer interactions and are not architected as integrated recruitment platforms. In particular, the server-side control logic often does not manage multi-turn interview sessions in a structured manner, does not systematically generate prompt sentences tuned to recruitment objectives, and does not coordinate conversational analysis results with multimodal emotion recognition. Consequently, even when a generative AI model is employed, the underlying computing system does not achieve a technically robust pipeline that can reliably transform raw conversational data into structured, machine-usable evaluation information for downstream decision support.

Additionally, in many existing systems, analysis of conversational content and emotional state is performed as separate, loosely coupled processes, if at all. A typical architecture may perform text analysis in one module and emotion recognition in another, without a unifying server-level mechanism to integrate these heterogeneous outputs into a single, structured evaluation report. This fragmentation leads to inefficiencies in data flow, redundant processing, and difficulty in standardizing evaluation scales. As a result, the computational infrastructure does not effectively support consistent, repeatable assessments that can be programmatically consumed, audited, or improved.

Furthermore, document screening often leaves certain evaluation items unaddressed, such as nuanced behavioral tendencies or context-dependent decision-making styles. Conventional systems do not provide a server-driven mechanism to detect these gaps and dynamically generate additional analysis prompt sentences for a generative AI model, based on the actual dialogue history and pre-defined screening requirements. Thus, the computer system cannot automatically refine its own analysis pipeline in response to missing information, which limits the adaptability and precision of the evaluation process.

There is therefore a need for an improved computer-implemented system in which a server controls end-to-end processing for interactive recruitment interviews, including: secure user session management; topic selection; automatic generation and update of prompt sentences for a generative AI model; multi-turn dialogue management and logging; coordinated language analysis and emotion estimation; and standardized, machine-generated evaluation reports. Such a system should enhance the technical operation of the server by structuring and orchestrating data flows between dialogue management, generative AI inference, emotion recognition, and scoring modules, thereby improving the reliability, scalability, and usefulness of computer-based recruitment support.

The specific processing by the specific processing unit 290 of the data processing device 12 in Example 1 is realized by the following means.

The present invention provides a server comprising a processor configured to authenticate a user by acquiring user identification information from a terminal device and comparing the user identification information with authentication information stored in a storage device, to generate a user session for dialogue processing based on an authentication result, to retrieve a plurality of topic candidates associated with the user session from the storage device and transmit the topic candidates to the terminal device as selectable items, to acquire topic information selected via the terminal device, to generate an initial prompt sentence based on the selected topic information for input to a generative AI model that performs interactive information processing, to transmit a dialogue start request including the initial prompt sentence to the generative AI model, to acquire a first question sentence from the generative AI model, and to store the first question sentence as part of a dialogue history while transmitting the first question sentence to the terminal device. The processor is further configured to receive, from the terminal device, user utterance data including a response sentence to the first question sentence, to sequentially store the user utterance data in the dialogue history, to convert the dialogue history into an input data format for the generative AI model, to transmit the converted dialogue history to the generative AI model, to acquire, from the generative AI model, a follow-up question sentence for additional input, and to store and transmit the follow-up question sentence to the terminal device so as to perform repeated dialogue control; to generate an analysis prompt sentence for extracting evaluation information indicating personality characteristics and thought patterns of the user by performing language analysis processing on the user utterance data included in the dialogue history, and to input the analysis prompt sentence and the dialogue history into the generative AI model so as to acquire an analysis result; to associate the dialogue history including the user utterance data with an emotion recognition function that executes an emotion estimation process based on expression data and voice data of the user, to acquire an emotion estimation result from the emotion recognition function, to integrate the emotion estimation result with the analysis result from the generative AI model so as to generate evaluation information that evaluates characteristics and emotional aspects of the user, and to generate an evaluation report document used for supporting recruitment activities based on the evaluation information and the dialogue history and output the evaluation report document as document data. This enables the server to technically improve recruitment support processing by orchestrating session management, dynamic prompt generation, multi-turn dialogue control, integrated language and emotion analysis, and standardized report generation in a unified computational workflow, thereby enhancing the quality, consistency, and machine-readability of candidate evaluations and improving the overall performance and utility of the computer system.

The term “user” refers to an individual who accesses the system via a terminal device and participates in a dialogue for evaluation, such as a candidate in a recruitment process.

The term “terminal device” refers to an information processing apparatus operated by the user, such as a workstation, a portable computer, a tablet device, or a mobile communication device, that executes a user interface and communicates with the server over a communication network.

The term “server” refers to an information processing apparatus comprising at least one processor and at least one storage device, the server being configured to execute authentication processing, dialogue management, communication with a generative AI model, analysis processing, and report generation.

The term “processor” refers to a hardware computation unit, such as a central processing unit or an execution core, that executes computer-executable instructions to perform the functions described for the system.

The term “storage device” refers to a non-transitory computer-readable medium, such as a semiconductor memory, a magnetic storage apparatus, or an optical storage apparatus, that stores programs, parameters, authentication information, dialogue histories, and evaluation information.

The term “user identification information” refers to information used to identify the user within the system, such as a login identifier, an account identifier, or equivalent authentication-related data.

The term “authentication information” refers to information used for verifying the identity of the user, such as a password, a credential token, or any data used for comparison with user identification information to determine authentication.

The term “user session” refers to a logical association managed by the server that represents an authenticated interaction state of a user, including session identifiers, timestamps, and related dialogue control parameters.

The term “topic candidate” refers to a piece of topic information, such as a predefined theme or subject category, that can be selected by the user as the basis for a dialogue with the generative AI model.

The term “topic information” refers to information indicating a specific topic selected by the user from among the topic candidates, and is used by the server to generate prompt sentences and control dialogue content.

The term “generative AI model” refers to a computational model implementing a generative artificial intelligence technique, such as a large-scale neural network, that receives text input including prompt sentences and outputs generated text such as questions, analysis results, or other natural language responses.

The term “prompt sentence” refers to a text string or set of text strings provided as input to the generative AI model, the prompt sentence defining instructions, context, or questions that guide the behavior and output of the generative AI model.

The term “initial prompt sentence” refers to a prompt sentence generated based on the selected topic information and used to initiate a dialogue with the generative AI model, typically instructing the model to produce a first question sentence to the user.

The term “dialogue start request” refers to a request message transmitted from the server to the generative AI model that includes at least the initial prompt sentence and requests generation of a first question sentence or equivalent initial output.

The term “first question sentence” refers to an initial natural language question generated by the generative AI model in response to the dialogue start request and presented to the user to begin the interactive dialogue.

The term “user utterance data” refers to data representing natural language responses or other textual inputs provided by the user through the terminal device in reply to question sentences generated by the generative AI model.

The term “dialogue history” refers to a stored sequence of interaction records including at least question sentences and user utterance data, optionally together with timestamps and speaker roles, representing the chronological content of the dialogue.

The term “follow-up question sentence” refers to a question generated by the generative AI model, after receiving one or more user utterances, for the purpose of continuing or deepening the dialogue with the user.

The term “repeated dialogue control” refers to server-side processing that iteratively transmits user utterance data and dialogue history to the generative AI model, receives follow-up question sentences, stores them in the dialogue history, and presents them to the user in multiple turns.

The term “language analysis processing” refers to processing for analyzing text data, including user utterance data and dialogue history, such as parsing, semantic extraction, or feature extraction, which is used to derive evaluation information concerning personality characteristics and thought patterns.

The term “analysis prompt sentence” refers to a prompt sentence generated by the server for input to the generative AI model, the analysis prompt sentence instructing the generative AI model to analyze the dialogue history and to output evaluation information or analysis results.

The term “analysis result” refers to information output by the generative AI model in response to the analysis prompt sentence, the analysis result including at least evaluation or descriptive content regarding personality characteristics, thought patterns, or related attributes of the user.

The term “expression data” refers to data representing the user's physical expressions, such as facial images or motion information, which can be used by an emotion recognition function to estimate the user's emotional state.

The term “voice data” refers to audio data representing the user's speech, including features such as tone, pitch, and intensity, which is used by an emotion recognition function to estimate the user's emotional state.

The term “emotion recognition function” refers to a computational function, which may include a trained model, configured to execute an emotion estimation process based on expression data and voice data to output emotion estimation results indicating a user's emotional state.

The term “emotion estimation result” refers to output data from the emotion recognition function indicating estimated emotional states or tendencies of the user during the dialogue, such as levels of stress, confidence, or other affective attributes.

The term “evaluation information” refers to data that evaluates or characterizes the user based on integrated analysis of at least the analysis result from the generative AI model and the emotion estimation result, including characteristics and emotional aspects of the user.

The term “evaluation report document” refers to a structured document generated by the server based on the evaluation information and the dialogue history, the document being used to support recruitment activities by presenting standardized and machine-generated assessments.

The term “document data” refers to digital data representing the evaluation report document in a storable and transferable form, such as a file encoded in a markup, document, or portable document format.

The term “selection information” refers to information indicating evaluation items or assessment points that were not sufficiently addressed during a document screening stage and that are to be additionally analyzed using the dialogue history and the generative AI model.

The term “additional analysis prompt sentence” refers to a prompt sentence generated by the server based on the selection information and the dialogue history, the additional analysis prompt sentence instructing the generative AI model to perform additional analysis targeted to missing or insufficient evaluation items.

The term “additional analysis result” refers to information output by the generative AI model in response to the additional analysis prompt sentence, the additional analysis result supplementing the original analysis result to improve completeness of the evaluation.

The term “scoring process” refers to processing that maps analysis results output by the generative AI model to values on a predetermined evaluation scale, such as numerical scores, for standardized and quantitative representation of evaluation items.

The term “evaluation scale” refers to a predefined scheme for quantifying evaluation items, such as a numerical range or categorical levels, which is used to express characteristic evaluation items and risk evaluation items in a consistent, machine-readable manner.

The term “characteristic evaluation item” refers to an evaluation component in the evaluation report document that represents a quantitative or qualitative assessment of a particular attribute or trait of the user, based on the scoring process.

The term “risk evaluation item” refers to an evaluation component in the evaluation report document that represents a quantitative or qualitative assessment of potential risks or concerns associated with the user's characteristics or behavior, based on the scoring process.

In one embodiment, a server, a terminal, and a user cooperate to implement the invention. The server includes at least one processor, a main memory, a non-transitory storage device, and a network interface. The terminal includes a processor, a display, an input interface such as a keyboard or touch panel, and a communication interface such as a wireless or wired network adapter. The user operates the terminal to access the server over a communication network.

The server executes an operating system such as a general-purpose server operating system and executes one or more application programs written in a high-level programming language. The application programs include a web server component, an authentication component, a dialogue management component, an interface component to a generative AI model, an emotion recognition component, an analysis and scoring component, and a report generation component. The server stores executable instructions and data structures in the storage device, such as a magnetic disk or solid-state drive.

The terminal executes a browser application or a dedicated client application. The terminal displays graphical user interface elements including login screens, topic selection screens, and dialogue screens. The terminal sends user input data, including user identification information, selected topic information, and user utterance data, to the server via the communication network using a secure protocol such as HTTPS.

The server stores structured data in one or more databases. The server uses relational tables or other structured data stores to record user accounts, authentication information, topic candidates, conversation sessions, dialogue histories, transcripts, emotion recognition results, analysis results, and evaluation report documents. The server indexes these data structures using identifiers such as user IDs, session IDs, and topic IDs to enable efficient retrieval and update.

The server uses a generative AI model for interactive information processing and analysis. In one embodiment, the generative AI model is a transformer-based neural network with multiple self-attention layers, positional encoding, and feed-forward sublayers. The generative AI model is trained with a sequence-to-sequence objective on large-scale natural language corpora. The generative AI model receives a tokenized representation of one or more prompt sentences and outputs a sequence of tokens corresponding to a generated natural language response. The server interacts with the generative AI model through an application programming interface, sending structured model input and receiving structured model output.

The server uses an emotion recognition function to estimate an emotional state of the user. In one embodiment, the emotion recognition function comprises a convolutional neural network or a convolutional-recurrent network for processing facial image data as expression data and a recurrent neural network or transformer-based network for processing voice spectrogram data as voice data. The server receives expression data and voice data from sensors associated with the terminal, such as a camera and a microphone, after appropriate user consent is obtained. The server preprocesses the image data by resizing, normalizing pixel values, and optionally extracting facial keypoints. The server preprocesses the voice data by performing sampling, framing, windowing, and computing spectral features such as Mel-frequency cepstral coefficients or log-mel spectrograms. The emotion recognition function outputs emotion estimation results, for example, as probability distributions or continuous scores for emotional dimensions such as valence and arousal.

The server maintains a data flow that connects user interaction, dialogue content, emotion estimation, and analytical processing. The server stores each user utterance and each question sentence from the generative AI model as entries in a dialogue history. Each entry includes at least a role indicator (user or AI), a timestamp, textual content, and a session identifier. The server uses this dialogue history both as an input to the generative AI model and as a basis for analysis and report generation.

The server generates prompt sentences for the generative AI model in a controlled and structured manner. For example, the server generates an initial prompt sentence for a leadership topic as:

“You are an interviewer evaluating a candidate's leadership abilities. Ask one open-ended question that encourages the candidate to describe a concrete leadership experience.”

The server encodes the prompt sentence into tokens using a tokenizer associated with the generative AI model and constructs an input sequence that includes a role indicator (such as a system role) together with the prompt sentence. The design of the prompt sentence specifies the role, objective, and style of questioning, thereby constraining the model's behavior and reducing variance in generated questions. This structure improves the reproducibility and consistency of interview questions compared with ad hoc or manually written questions.

The server generates an analysis prompt sentence for post-dialogue evaluation. For example, the server generates an analysis prompt sentence as:

“You are an expert recruitment analyst. Analyze the following conversation between an interviewer (AI) and a candidate (User). Identify the candidate's personality traits, thought patterns, leadership style, communication style, strengths, and potential risks. Provide a structured summary suitable for a recruitment report.”

The server concatenates the analysis prompt sentence with the dialogue transcript, including labels such as “AI:” and “User:”, and transmits this combined text to the generative AI model. The generative AI model processes the combined text as a sequence, computing contextual embeddings at each layer using self-attention. The server then receives an analysis result in the form of text or a structured representation.

The server generates additional analysis prompt sentences when document screening indicates that certain evaluation items are not sufficiently addressed. The server retrieves selection information that encodes missing evaluation items, such as “long-term motivation”, “stress tolerance”, or “ethical decision-making.” The server generates a specific additional analysis prompt sentence using rule-based templates that reference both the selection information and the dialogue history. For example, the server may generate:

“Based on the conversation below, evaluate the candidate's long-term motivation for career development and their approach to stress management. Identify any specific behaviors or statements that indicate high or low motivation and resilience.”

The server thereby uses explicit rules to convert missing assessment points and historic dialogue content into new, targeted analytical requests to the generative AI model. This rule-based generation mechanism differs from conventional manual question writing and provides a deterministic and repeatable algorithm for guiding the generative AI model.

The server performs language analysis processing not only by delegating analysis to the generative AI model but also by performing local preprocessing and feature extraction. The server may apply tokenization, part-of-speech tagging, sentence boundary detection, and basic syntactic parsing using conventional natural language processing libraries. The server may derive quantitative features such as average sentence length, lexical diversity, frequency of certain modal expressions, and occurrence of specific syntactic patterns related to assertiveness or caution. The server may use these features as additional inputs to the analysis and scoring component. This combined use of external generative AI output and internal feature extraction allows the server to cross-check and stabilize evaluation results, thereby improving robustness and reducing noise.

The server performs a scoring process to map qualitative analysis results into a predetermined evaluation scale. The server defines evaluation scales for different trait dimensions, such as a five-level or seven-level scale for “initiative”, “cooperativeness”, “logical reasoning”, and “risk sensitivity.” The server parses the analysis result, which may describe traits in natural language, using pattern-based rules and mapping tables. For example, the server maps expressions like “very strong tendency to take initiative” or “often shows proactive behavior” to high scores on an initiative scale. The server also uses thresholds in quantitative features derived from the dialogue, such as the frequency of first-person plural pronouns compared to first-person singular pronouns, as part of the scoring logic. The server stores the resulting numerical scores in a structured format linked to the user session.

The server generates the evaluation report document based on the evaluation information and the dialogue history. The server uses a document template that defines sections such as “Summary”, “Personality and Leadership Traits”, “Communication Style”, “Emotional Stability”, and “Potential Risks”. The server inserts text snippets from the analysis result into appropriate sections and embeds quantitative scores in tabular form. The server converts the assembled document into a portable document format. The server may compress the document using a standard compression algorithm and store it in the storage device or in a remote file storage system.

The server thereby improves computer technology in several respects. The server reduces communication load by transmitting only compact prompt sentences and incremental dialogue exchanges to the generative AI model rather than transmitting entire raw data streams repeatedly. The server reduces internal processing load by maintaining a structured dialogue history and by reusing previously computed features and analysis results. The server improves processing speed by caching intermediate context representations and by limiting the context window presented to the generative AI model to the most relevant segments of the dialogue. The server improves accuracy and reliability by integrating independent emotion recognition outputs with dialogue-based analysis results, thereby correcting for biases or misinterpretations that could arise from purely text-based analysis.

The server configures the neural network parameters of the generative AI model and the emotion recognition function using machine learning methods. During training, the generative AI model minimizes a loss function such as cross-entropy between predicted tokens and target tokens over large, general-purpose text corpora and domain-specific training datasets. The training process applies gradient-based optimization, such as stochastic gradient descent with adaptive learning rate methods, and updates weight matrices and bias parameters across multiple layers. The server or a separate training system applies dropout and regularization techniques to prevent overfitting. The emotion recognition function is trained on labeled datasets containing pairs of expression data or voice data and corresponding emotion labels, using a loss function such as categorical cross-entropy for classification of discrete emotion categories or mean squared error for regression to continuous emotion scores. After training, the server deploys the trained models in an inference configuration optimized for low-latency processing.

The server uses non-conventional processing flows and data structures that are different from simple automation of human tasks. For example, the server does not simply replicate human interviewers'free-form questioning. Instead, the server uses algorithmically generated prompt sentences, rule-based additional analysis prompts, and structured mapping of generative outputs to quantitative scores. The server uses non-human decision rules, such as counting specific linguistic features and applying deterministic mapping tables, to produce consistent and reproducible trait assessments. This approach cannot easily be performed by human interviewers at scale or at the same level of computational consistency.

The server manages communication between the terminal, the generative AI model, and the emotion recognition function in a coordinated manner that improves data management. The server maintains separate modules for authentication, dialogue logging, emotion processing, and analysis, each with defined interfaces. The server uses structured identifiers and normalized database schemas to minimize redundancy and ensure traceability of evaluation results back to original dialogue entries and raw sensor data. This traceability enables technical auditing and further optimization of algorithms.

The terminal captures expression data and voice data in synchronization with dialogue events. The terminal attaches timestamps and identifiers to images and audio samples and transmits them to the server. The terminal may perform preliminary compression or feature extraction, such as encoding video frames into a compressed format and encoding audio into a reduced-bitrate stream, thereby reducing network bandwidth consumption. By synchronizing the transmission of audio-visual data with textual dialogue events, the system enables a technically coordinated inference pipeline that associates emotional states with specific utterances.

The user interacts with the system by selecting topics and answering questions in natural language. The user is not required to understand the internal workings of the generative AI model or the emotion recognition function. The user's natural speech and expressions are transformed by the server into structured evaluation information through the combination of prompt-driven generative processing, multimodal feature extraction, and rule-based scoring. The user thereby benefits from more precise and technically consistent evaluation without manual interpretation of complex data.

In alternative embodiments, the server may use different neural network architectures for the generative AI model, such as encoder-decoder transformers or hybrid recurrent-transformer architectures. The server may use different feature sets for emotion recognition, such as using facial action units instead of raw pixel data, or prosodic features such as speaking rate and pitch variability in addition to spectral features. The server may store dialogue histories in non-relational data stores or graph databases, enabling more complex retrieval based on conversation structure. The server may adjust the evaluation scales for different use cases, for example, by adding dimensions specific to certain job categories.

The server may also vary the design of prompt sentences. For example, for teamwork evaluation, the server may generate an initial prompt sentence such as: “You are an interviewer evaluating a candidate's teamwork skills. Ask one open-ended question that encourages the candidate to describe a specific experience working in a team.”

For problem-solving evaluation, the server may generate:

“You are an interviewer evaluating how a candidate approaches complex problem solving. Ask one open-ended question that encourages the candidate to explain a problem they faced and how they solved it.”

These variations demonstrate that the server uses prompt sentences systematically to configure and specialize the generative AI model's behavior for different evaluation objectives.

By combining structured prompt sentence generation, controlled multi-turn dialogue, multimodal emotion recognition, feature-based analysis, and deterministic scoring, the server implements a computer-implemented architecture that enhances processing speed, precision, and consistency over conventional systems. The server thereby provides a concrete technical solution to the problem of converting complex, real-time conversational and emotional data into standardized, machine-readable evaluation reports in a scalable and reproducible way.

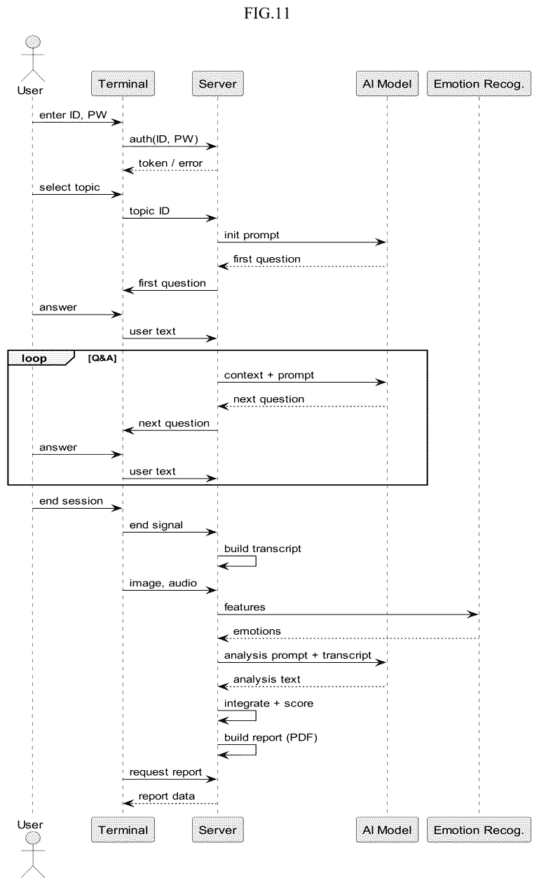

The following describes the processing flow using FIG. 11.

### Step 1:

The terminal displays a login screen and receives a user ID and password from the user.

The input is character data typed by the user via a keyboard or touch panel.

The terminal packages the user ID and password into an HTTPS request and transmits the request to the server over a communication network.

The output of the terminal is a structured authentication request containing the user ID and password fields.

### Step 2:

The server receives the authentication request and performs user authentication.

The input is the user ID and password contained in the HTTPS request.

The server executes a query against an authentication table in a storage device to retrieve a stored password hash corresponding to the user ID, applies a hashing algorithm to the received password, compares the calculated hash with the stored hash, and determines whether the user is valid.

The output of the server is either an authentication success message including a session token or an authentication failure message.

### Step 3:

The terminal receives the authentication result and updates its internal state.

The input is the session token or failure message returned by the server.

The terminal stores the session token in a local memory area when authentication is successful and switches the display from the login screen to a main menu screen; when authentication fails, the terminal displays an error message and keeps the login screen active.

The output of the terminal is a visible main menu screen when authentication succeeds or a visible error message when it fails.

### Step 4:

The server creates a user session for dialogue processing when authentication succeeds.

The input is the user ID and the authentication success result.

The server generates a session identifier, records the session identifier, user ID, and creation timestamp in a session table in the storage device, and associates default parameters such as allowed topics and time limits with the session.

The output of the server is a persistent session record and the session identifier returned to the terminal.

### Step 5:

The server retrieves topic candidates and sends them to the terminal.

The input is the session identifier received from the terminal.

The server queries a topic table in the storage device to fetch multiple topic records, each including a topic ID and a topic description, filters the topics based on system rules if necessary, converts them into a structured list, and transmits the list to the terminal.

The output of the server is a set of topic candidate data objects.

### Step 6:

The terminal displays the topic candidate list and receives a selected topic from the user.

The input is the list of topic candidate data objects from the server.

The terminal renders each topic as a selectable item on the display, the user taps or clicks one item, and the terminal captures the associated topic ID as selection data.

The output of the terminal is a topic selection request containing the session identifier and the selected topic ID.

### Step 7:

The server generates an initial prompt sentence for the generative AI model based on the selected topic.

The input is the selected topic ID linked to the active session.

The server retrieves the corresponding topic description from the storage device, inserts the topic description into a template for an initial prompt sentence, and creates a text such as “You are an interviewer evaluating a candidate's leadership abilities. Ask one open-ended question that encourages the candidate to describe a concrete leadership experience.”

The output of the server is the initial prompt sentence as a text string.

### Step 8:

The server sends a dialogue start request including the initial prompt sentence to the generative AI model and acquires a first question sentence.

The input is the initial prompt sentence.

The server tokenizes the prompt sentence using a tokenizer compatible with the generative AI model, constructs a model input structure including role information and tokens, transmits this structure to the generative AI model via an API call, and receives a generated output sequence which it detokenizes to a natural language question.

The output of the server is a first question sentence generated by the generative AI model.

### Step 9:

The server stores the first question sentence in a dialogue history and sends it to the terminal.

The input is the first question sentence text.

The server inserts a record into a dialogue history table including the session identifier, a role field set to “AI,” the question text, and a timestamp, and constructs a response message containing the question text for the terminal.

The output of the server is an updated dialogue history and a question display message transmitted to the terminal.

### Step 10:

The terminal displays the first question sentence and receives a user response as user utterance data.

The input is the first question sentence text received from the server.

The terminal updates the dialogue view to show the AI question, activates a text input field, and captures the user's typed response such as “I think a good leader should listen carefully and make decisions transparently . . . ”.

The output of the terminal is a user utterance message containing the session identifier and the response text.

### Step 11:

The server records the user utterance data and updates the dialogue history.

The input is the user utterance message containing the response text.

The server inserts a new dialogue history record with the session identifier, a role field set to “user,” the response text, and a timestamp, and maintains an ordered sequence of records for the session.

The output of the server is an extended dialogue history including both AI and user turns.

### Step 12:

The server constructs a dialogue context for the generative AI model and requests a follow-up question sentence.

The input is the current dialogue history for the session.

The server retrieves recent dialogue entries from the storage device, formats each entry into a sequence with role tags and content, concatenates them to create a context text, appends a control instruction such as “Continue the interview on leadership and ask one follow-up question,” and sends this combined context as a prompt sentence to the generative AI model via the API.

The output of the server is a generated follow-up question sentence returned from the generative AI model.

### Step 13:

The server stores the follow-up question sentence and transmits it to the terminal.

The input is the follow-up question sentence.

The server adds a new “AI” role record to the dialogue history with the follow-up question and timestamp and packs the question text into a message addressed to the terminal.

The output of the server is an updated dialogue history and a follow-up question display message.

### Step 14:

The terminal displays the follow-up question and the user repeats answering, while the terminal transmits each new user utterance to the server.

The input is each follow-up question sentence received from the server.

The terminal appends the question to the chat interface, collects the user's answer through the input field, and sends a user utterance message back to the server for each turn.

The output of the terminal is a sequence of user utterance messages that extend the dialogue.

### Step 15:

The server continues repeated dialogue control until a termination condition is met.

The input is the sequence of user utterance messages and generated follow-up questions.

The server, for each new user utterance, updates the dialogue history, constructs a new context, sends a new prompt sentence to the generative AI model, and acquires and stores a new follow-up question, checking conditions such as maximum number of turns or explicit end requests.

The output of the server is a complete dialogue history and an indication that the dialogue session has ended.

### Step 16:

The user or the terminal signals the end of the dialogue session.

The input is an end-operation such as pressing an “End Interview” button on the terminal interface.

The terminal wraps this operation as a session termination request including the session identifier and transmits it to the server.

The output of the terminal is a termination message indicating that no further dialogue is requested.

### Step 17:

The server finalizes the session and aggregates the dialogue history into a transcript.

The input is the termination message and the dialogue history for the session.

The server updates the session record to mark the status as completed, retrieves all dialogue history records in chronological order, concatenates the question and answer texts into a single transcript labeled with “AI:” and “User:” markers, and stores the transcript in a transcript table.

The output of the server is a structured transcript associated with the session.

### Step 18:

The server acquires expression data and voice data associated with the dialogue, and executes emotion estimation.

The input is synchronized image frames and audio segments received from the terminal during the dialogue.

The server preprocesses the frames by cropping faces and normalizing image size, preprocesses audio by computing spectral features, feeds these features into trained neural network models for expression and voice analysis, and computes emotion estimation results such as probability vectors over emotional categories or continuous emotion scores.

The output of the server is emotion estimation data linked to time intervals and, by alignment, to specific dialogue turns.

### Step 19:

The server generates an analysis prompt sentence and analyzes the dialogue using the generative AI model.

The input is the transcript text and, optionally, summary statistics of the dialogue.

The server creates an analysis prompt sentence such as “You are an expert recruitment analyst. Analyze the following conversation...”, concatenates the prompt with the transcript, tokenizes the combined text, and sends it to the generative AI model through the API to obtain an analysis result describing personality traits, thought patterns, and other attributes.

The output of the server is an analysis result in natural language or structured text.

### Step 20:

The server integrates the analysis result from the generative AI model with the emotion estimation data to generate evaluation information.

The input is the textual or structured analysis result and the emotion estimation data.

The server parses the analysis result to identify trait descriptors, computes trait scores on predefined scales, aligns emotion scores with dialogue segments where key statements occur, and combines these values into composite indicators of behavior and emotional tendencies.

The output of the server is unified evaluation information describing characteristics and emotional aspects of the user.

### Step 21:

The server generates additional analysis prompt sentences when document screening indicates missing evaluation items.

The input is selection information representing unaddressed evaluation points and the dialogue transcript.

The server references rule-based templates linking selection items to analytical questions, automatically composes additional analysis prompt sentences that reference specific parts of the transcript, and transmits these prompt sentences as additional inputs to the generative AI model; it then receives and parses additional analysis results.

The output of the server is extended evaluation information that covers previously missing items.

### Step 22:

The server performs a scoring process to convert evaluation information into quantitative scores.

The input is the combined evaluation information including traits, risks, and emotion indicators.

The server applies mapping tables and threshold rules to convert qualitative labels and descriptors into numerical scores on predetermined scales, normalizes scores if necessary, and stores the scores in an evaluation record associated with the session and user.

The output of the server is a structured set of scores for characteristic evaluation items and risk evaluation items.

### Step 23:

The server generates an evaluation report document based on the evaluation record and the dialogue history.

The input is the evaluation scores, textual analysis summaries, and selected excerpts of the dialogue.

The server fills a report template with summary text, tables of scores, and representative quotes from the transcript, arranges the content into sections, and converts the assembled content into a document file format such as a portable document format.

The output of the server is document data representing the evaluation report document.

### Step 24:

The terminal receives a report access command from a recruiter and displays or downloads the evaluation report document.

The input is a report list screen generated by the server and a recruiter's selection of a particular report.

The terminal sends a report request including a report identifier, receives the corresponding document data from the server, and either renders the document in an embedded viewer or stores the document file for local viewing.

The output of the terminal is a visual presentation of the evaluation report document to the recruiter.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented customer support systems that utilize speech recognition and recommendation logic often treat user utterances as isolated commands or simple keyword queries. Such systems typically rely on static rule sets or shallow pattern matching, and therefore fail to exploit the full conversational context and inferred user state across time. As a result, these systems exhibit limited accuracy in estimating a customer's underlying needs and preferences, and they are unable to generate high-quality, reusable persona information that can be leveraged in later sessions. Consequently, the computational resources of the server and associated recognition and recommendation components are not effectively utilized, leading to suboptimal throughput, unnecessary round trips, and redundant processing for repeated or similar interactions.

Moreover, when generative AI models are used in existing systems, they are often invoked with ad-hoc or poorly structured input. For example, raw transcripts or short, contextless messages are directly sent to the generative AI model without any systematic prompt construction or data conditioning. This causes unstable output quality, inconsistent estimation of demand and preference information, and increases the likelihood that the generative AI model will return irrelevant or overly verbose results. The lack of a structured prompt strategy leads to inefficient token usage, longer processing times, and increased load on server-side computational resources, thereby degrading overall system performance.

In addition, conventional systems typically separate real-time support from long-term profiling. They may provide real-time recommendations based on current utterances, or independently store logs for later analysis, but they do not integrate these two flows into a unified computational pipeline. As a result, personas or reports, if generated at all, are often produced manually or in a batch process disconnected from the live interaction. This separation prevents the system from reusing the computationally expensive analysis performed during the live session when constructing reports, and obliges additional post-processing, which wastes processor cycles and introduces latency and inconsistency.

There is therefore a need for an improved computer-implemented system and method that (i) structures dialogue history as machine-usable dialogue history information, (ii) constructs optimized prompt sentences that emphasize phrases relevant to demand and preference information, (iii) interacts with a generative AI model in a controlled manner, and (iv) integrates real-time recommendation and report generation into a single processing framework. Such a system should reduce redundant processing, improve the accuracy and stability of generative AI outputs, and enhance the efficiency with which server resources are used to support both immediate customer assistance and later customer service sessions.

The specific processing by the specific processing unit 290 of the data processing device 12 in Application Example 1 is realized by the following means.

The present invention provides a server comprising a processor configured to acquire dialogue content of a dialogue between a user and a generative AI model based on a predetermined theme, convert speech information and acoustic feature information obtained via an image information acquisition device and an audio information acquisition device into character information by using a speech recognition processing device, and generate dialogue history information including the character information; generate a prompt sentence based on the dialogue history information and the predetermined theme, and transmit the prompt sentence and the dialogue history information to the generative AI model to acquire an analysis result in which demand information and preference information of the user or a dialogue partner are estimated; search, based on the analysis result, a plurality of candidate information items from at least one of a merchandise information storage device and a service information storage device, and select and rank the candidate information items according to a degree of relevance to the demand information and the preference information; format the selected and ranked candidate information items into display information that is displayable in real time on a visual display device, and present the display information to the user as an assistance tool for customer service activities; generate report information including at least a persona, a characteristic, the demand information, and the preference information of the dialogue partner based on the dialogue history information and the analysis result, and store the report information in a storage device; and output the stored report information in a form referable in customer service activities performed at a later time. This enables the server to implement an integrated computational pipeline in which dialogue history information is incrementally structured, prompt sentences are optimized for interaction with the generative AI model, real-time recommendation processing and long-term persona report generation share common intermediate analysis results, and processor, memory, and network resources are used more efficiently to achieve improved accuracy, stability, and responsiveness of computer-implemented customer support functions.

The term “dialogue” refers to a sequence of exchanges of information, including at least one utterance from a user and one response from another party such as a dialogue partner or a generative AI model, carried out in a natural language over time.

The term “user” refers to a human operator who interacts with a dialogue partner while using the system and who receives assistance information via a visual display device.

The term “dialogue partner” refers to a human or artificial entity that participates in the dialogue with the user and whose demand information, preference information, persona, and characteristics are to be estimated by the system.

The term “generative AI model” refers to a machine learning model configured to generate natural language output and analyze input text by performing probabilistic inference over sequences of tokens, and which is invoked by the processor via an interface such as an application programming interface.

The term “predetermined theme” refers to a topic or subject matter set in advance of the dialogue and used by the processor as a contextual constraint or guide when managing the dialogue and constructing prompt sentences for the generative AI model.

The term “dialogue content” refers to information representing utterances in the dialogue, including text, speech signals, or encoded data that capture what the user and the dialogue partner have expressed.

The term “speech information” refers to audio data that represents spoken utterances of the user or the dialogue partner, including temporal waveforms or compressed representations of voice signals.

The term “acoustic feature information” refers to information derived from speech information that characterizes properties of the audio signal, such as pitch, volume, timbre, or prosodic features, and that can be used for recognition or analysis processing.

The term “image information acquisition device” refers to an apparatus configured to acquire visual information, such as a camera or an imaging sensor mounted on a wearable device, capable of capturing images or video related to the dialogue.

The term “audio information acquisition device” refers to an apparatus configured to acquire sound information, such as a microphone or an array of microphones, capable of capturing speech produced by the user or the dialogue partner.

The term “speech recognition processing device” refers to a hardware and software combination configured to convert speech information into character information by performing automatic speech recognition processing.

The term “character information” refers to text data representing linguistic content of spoken utterances, obtained by converting speech information through speech recognition processing.

The term “dialogue history information” refers to structured data representing a time-ordered record of dialogue content, including character information, speaker labels, timestamps, and optionally additional metadata related to the dialogue.

The term “prompt sentence” refers to a text sequence constructed by the processor and provided as input to the generative AI model, the text sequence including instructions, context, and portions of the dialogue history information to guide analysis or generation by the generative AI model.

The term “analysis result” refers to data output from the generative AI model in response to a prompt sentence, the data including at least inferred demand information and preference information for the user or the dialogue partner.

The term “demand information” refers to information indicative of needs, requests, or requirements of the user or the dialogue partner that are inferred from the dialogue content.

The term “preference information” refers to information indicative of likes, dislikes, priorities, or tendencies of the user or the dialogue partner that are inferred from the dialogue content.

The term “merchandise information storage device” refers to a storage resource, such as a database, configured to store information about goods, including attributes such as category, description, and price.

The term “service information storage device” refers to a storage resource, such as a database, configured to store information about services, including attributes such as service type, conditions, and availability.

The term “candidate information items” refers to pieces of information retrieved from at least one of the merchandise information storage device and the service information storage device, which are potential recommendations or outputs to be selected and ranked according to relevance.

The term “degree of relevance” refers to a value or measure representing how closely a candidate information item matches or satisfies the demand information and the preference information inferred for the user or the dialogue partner.

The term “visual display device” refers to an apparatus configured to visually present information to the user, such as a head-mounted display, smart glasses, a monitor, or another visual output interface.

The term “display information” refers to data formatted for presentation on the visual display device, including text and optionally simple graphical elements, arranged so that the user can recognize and use the information in real time.

The term “assistance tool for customer service activities” refers to a computer-implemented function or user interface that supports the user in interacting with a dialogue partner, by providing recommendations, summaries, or guidance derived from the analysis result.

The term “persona” refers to a profile of the dialogue partner, including generalized descriptions of characteristics, behaviors, and tendencies inferred from the dialogue history information and the analysis result.

The term “characteristic” refers to a trait or attribute of the dialogue partner, such as a behavioral tendency, value orientation, or preference pattern, inferred by the system.

The term “report information” refers to structured or semi-structured data representing at least the persona, characteristic, demand information, and preference information of the dialogue partner, which is generated by the processor and stored for later reference.

The term “storage device” refers to a memory resource, such as a non-volatile storage medium or a database system, configured to store dialogue history information, report information, and other data used by the processor.

The term “form referable in customer service activities” refers to a representation of the report information that can be retrieved and presented to the user in a human-readable or machine-usable manner, thereby enabling use of the report information in subsequent customer interactions.

A system according to embodiments of the present invention includes at least a server, a terminal, and a network connecting them. The server includes at least one processor, a main memory, a non-volatile storage device, and a network interface. The terminal includes at least a processor, a memory, a visual display device, and an audio information acquisition device, and may further include an image information acquisition device such as a camera. The visual display device can be realized by a head-mounted display, smart glasses, or a portable display. The audio information acquisition device can be realized by a microphone or an array microphone integrated in the terminal.

The server executes a computer program stored in the storage device and loaded into the main memory. The program is implemented, for example, as one or more software modules running on an operating system such as a generic server operating system. The server may use a web application framework, such as a general-purpose HTTP server and application server, to expose an application programming interface to the terminal. The server includes, in software, at least a speech recognition processing module, a dialogue history management module, a prompt sentence generation module, a generative AI interface module, an analysis result processing module, a recommendation module, and a report generation and storage module.

The terminal executes a client application implemented on an operating system suitable for wearable or mobile devices. The terminal application controls the microphone and display, acquires audio data during a real-world dialogue between a user and a dialogue partner, and sends the audio data and associated metadata to the server via the network interface. The terminal further receives display information from the server and renders the information on the visual display device in an overlaid manner such that the user can see real-time assistance information without losing sight of the dialogue partner.

The server uses a speech recognition processing device configured as a software module that may run on one or more central processing units and, optionally, an accelerator such as a graphics processing unit. The speech recognition processing device may employ a neural automatic speech recognition model, such as a sequence-to-sequence model, a transformer-based acoustic model, or a hybrid connectionist temporal classification model. The speech recognition processing device converts raw audio waveforms, sampled at a fixed rate such as 16 kHz, into character information representing transcribed text. In one embodiment, the speech recognition processing device first computes acoustic feature information such as Mel-frequency cepstral coefficients, log-mel filter bank energies, or pitch contours, and then inputs these features into a trained neural network to output character sequences. This conversion reduces the data size and transforms unstructured acoustic signals into structured text data, improving data management efficiency for subsequent processing.

The server, via the dialogue history management module, structures the transcribed character information into dialogue history information. The dialogue history information may be represented as a time-ordered list or table of utterance records, each record including at least a speaker identifier, a timestamp, a text string, and optionally recognition confidence and acoustic feature statistics. The server stores this dialogue history information in a data structure such as a relational table in a database or a document in a document-oriented database. By structuring the dialogue history in this way, the server can efficiently retrieve recent utterances, aggregate context windows, and construct input sequences for the generative AI model without repeatedly scanning entire logs, thereby reducing processing time and memory usage.

The server uses the prompt sentence generation module to construct prompt sentences for the generative AI model. The prompt sentence generation module processes the dialogue history information to extract utterances within a predetermined time window or a predetermined number of turns. The module may perform natural language preprocessing, such as tokenization, part-of-speech tagging, or keyword extraction, to detect phrases representing demand information and preference information of the dialogue partner. The module then emphasizes these phrases in the prompt sentence by, for example, repeating them, surrounding them with explicit markers, or adding explanatory annotations such as “Key customer need:” or “Key preference:”.

In one concrete example, the server generates the following prompt sentence for real-time recommendation:
“You are a generative AI model assisting in real-time in-store customer service.
Theme: ‘healthy lifestyle and food choices’.
Recent conversation:
Staff (User): ‘What kind of product are you looking for today?’
Customer: ‘I'm interested in healthy food lately, especially something high in protein but low in sugar.’
Key customer need: healthy food, high in protein, low in sugar.
Based on the customer's latest utterance and the key customer need, identify the customer's main needs and preferences in 2 sentences, and suggest 5 product category ideas and one follow-up question the staff should ask. Answer in concise English.”

The server supplies, to the generative AI model, both the prompt sentence and the dialogue history information or a subset thereof. The generative AI model is implemented, in one embodiment, as a large-scale neural network having a transformer architecture with multiple encoder-decoder layers, multi-head self-attention mechanisms, and learned positional encodings. The generative AI model operates on tokenized sequences generated from the prompt sentence and context. Internal parameters of the model, such as weight matrices and bias vectors, are pretrained on large corpora and optionally fine-tuned on domain-specific dialogues.

The server, via the generative AI interface module, sends the tokenized prompt sentence to a model execution environment. The execution environment may run on a dedicated hardware platform, such as a graphics processing unit or tensor processing unit, which accelerates matrix multiplications and attention operations. The generative AI model performs, for each transformer layer, self-attention over the current token sequence, computes weighted combinations of hidden states, and propagates activations through feed-forward sub-networks. The model produces, at the output layer, a probability distribution over possible next tokens, from which the server samples or selects tokens to generate a natural language analysis result. This analysis result includes, for example, inferred demand information such as “interest in high-protein, low-sugar food” and inferred preference information such as “willingness to consider snacks and ready-to-eat products.”

By employing a transformer-based generative AI model with a structured prompt sentence and dialogue history information, the server achieves improved accuracy and stability of inferred demand and preference information, compared to conventional keyword-based or rule-based systems. The explicit emphasis of key phrases in the prompt sentence guides the attention mechanisms of the neural network toward relevant parts of the input, thereby reducing spurious outputs and improving convergence of the decoding process. This results in reduced computational overhead, because fewer repeated calls and corrections are needed to obtain usable recommendations.

The server uses the analysis result processing module and recommendation module to map the inferred demand information and preference information to structured candidate information items. The server stores merchandise information and service information in one or more storage devices as records including attributes such as category identifiers, feature vectors, price ranges, nutritional values, and promotion flags. The recommendation module receives, as input, a semantic representation of inferred needs and preferences, which can be encoded as a feature vector or as a set of weighted attribute tags. The module then executes a search algorithm over the merchandise information storage device and service information storage device. In one embodiment, the server performs an indexed query that filters candidate records by category and price range and then computes a similarity measure, such as cosine similarity or inner product, between an embedding of the inferred needs and embeddings of candidate items. The embeddings of items can be precomputed using a neural embedding model trained to map item descriptions into a continuous vector space.

The server ranks the candidate information items according to the similarity measure and additional criteria such as inventory status and promotion priority. The module may implement a weighted scoring function f(item)=α·similarity+β·promotion_score+γ·availability_score, where α, β, and γ are weighting parameters set according to system policies. By employing such a scoring function, the server controls the trade-off between relevance and business constraints at the technical level, and can compute recommendation results using vector operations that are efficiently performed by the processor or accelerator hardware.

The server formats the selected and ranked candidate information items into display information for the terminal. The display information is composed of concise text snippets, including product or service names, key selling points tied to the demand information and preference information, and optional follow-up questions for the user. The formatting module may include line-length constraints, character limits, and priority ordering to ensure that high-priority content appears first within the limited display area of the visual display device. The compact formatting reduces both the data size transmitted to the terminal and the cognitive load on the user, and thereby improves system responsiveness and usability in a real-world customer interaction environment.

The terminal receives the display information and controls the visual display device so that the information is rendered in an overlaid region near the user's field of view. The terminal may use an augmented reality rendering library to position the text in a non-obstructive manner. By coordinating display updates with network reception, the terminal ensures that the user receives new assistance information with low latency. This configuration achieves a technical effect of reducing network traffic and display updates, because only already-ranked and formatted information is transmitted, instead of large raw data or unfiltered lists.

The server further generates report information based on the dialogue history information and the analysis result. In one embodiment, after completion of a dialogue session, the server constructs another prompt sentence that instructs creation of a persona report. For example, the server may generate the following prompt sentence:
“You are a generative AI model that creates a customer persona report.
Below is the full transcript of a conversation between a store staff member and a customer.
Create a report including:
1) Main interests and needs
2) Lifestyle and values (if inferable)
3) Product preferences (category, price range, brand, style)
4) Recommended talking points and service tips for the next visit.
Write the report in clear English, around 300 words.
Transcript:
[full conversation text here].”

The server sends this prompt sentence and the complete dialogue history information to the generative AI model. The model processes the extended input sequence using its neural architecture, aggregating information across multiple turns and time steps. By encoding the entire dialogue history with multi-head self-attention layers, the model can identify consistent patterns and behaviors that may not be evident from any single utterance. The server receives the generated report information, which may be structured into sections according to the requested items, and stores this report in the storage device as a persistent persona profile.

To train the generative AI model and other neural components used in the system, a learning procedure may be employed in advance of deployment. In one embodiment, a supervised learning method is used, in which a large set of dialogue logs, associated demand and preference labels, and persona reports are prepared. The model parameters are initialized and then iteratively updated by minimizing an error function such as cross-entropy loss between predicted token sequences and ground-truth sequences. A gradient-based optimization algorithm, such as stochastic gradient descent with momentum or Adam, is applied to update weights based on backpropagated gradients. Data augmentation techniques, such as paraphrasing or noise injection into training dialogues, may be used to improve robustness against variations in user utterances. By performing such training on high-performance computing hardware, the system ensures that, at run time, the generative AI model can infer accurate analysis results with fewer tokens and lower latency, thereby exploiting computational resources more efficiently than conventional systems.

The server can also employ additional rule-based or non-conventional steps to further refine analysis results. For example, the analysis result processing module may apply a post-processing rule that rejects any inferred demand information or preference information not supported by at least a threshold number of corresponding phrases in the dialogue history information. The module can compute a phrase support score by counting occurrences of relevant terms in the dialogue history and discarding low-support hypotheses. This rule-based filtering, executed before database search, prevents unnecessary queries for irrelevant items and reduces server load, contributing to improved throughput and reduced communication overhead.

The described configuration provides more than simple automation of human judgment. The server implements a specific computational pipeline that leverages structured dialogue history information, optimized prompt sentences, and neural network-based inference and recommendation algorithms. By integrating these elements, the system improves technical aspects of computing, such as processing speed, memory utilization, communication efficiency, and accuracy of information retrieval. The design of the data structures, the emphasis-based prompt sentence generation, and the combined use of feature-based ranking and neural embedding similarities result in a non-conventional and technically advantageous way of controlling server resources and terminal displays.

Various modifications and alternative embodiments can be implemented. For example, the terminal may be realized by a handheld device rather than a head-mounted display, while still including an audio information acquisition device and a visual display device. The generative AI model may be executed locally on the server or on an external computational resource via a secure network, and different neural network architectures, such as recurrent neural networks or convolutional sequence models, may be used instead of or in addition to transformer architectures. The recommendation module may employ alternative ranking algorithms, such as learning-to-rank models trained with pairwise or listwise loss functions, to optimize ordering of candidate information items.

In another embodiment, the server may vary the length of the context window used for prompt sentence generation according to detected dialogue complexity. For short, simple interactions, the server may restrict the context window to reduce token count and latency. For longer, complex interactions, the server may selectively summarize earlier portions of the dialogue using a separate summarization module and include the summary in the prompt sentence, thereby maintaining context without excessive token usage. This adaptive context management further improves computational efficiency and stability of generative AI outputs.

In yet another embodiment, the system may include a feedback mechanism in which the user can input, via the terminal, evaluations of whether suggested candidate information items were appropriate. The server can store this feedback and use it to adjust parameters in the scoring function or to fine-tune neural components. By incorporating real usage feedback, the system can continuously optimize its internal algorithms and further improve technical performance over time.

Through these embodiments, the server, the terminal, and the generative AI model cooperate to realize a concrete, technical implementation that manages real-world audio acquisition, structured data transformation, optimized prompt sentence generation, neural-network-based inference, efficient database access, and constrained visual display, thereby enabling the invention to be practiced in a manner that is technically reproducible and that improves computer technology itself.

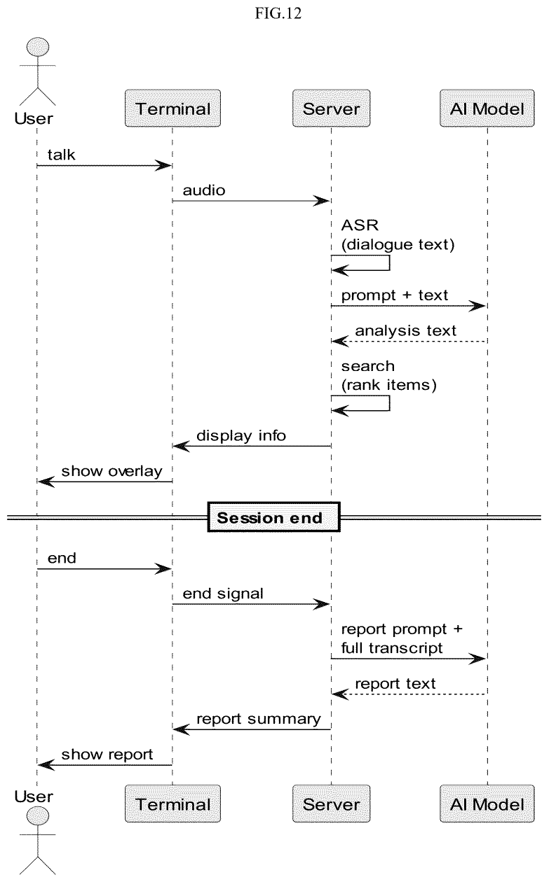

The following describes the processing flow using FIG. 12.

### Step 1:

The user starts a customer interaction while wearing the terminal.

The terminal activates a microphone and, optionally, a camera. The input is an analog voice signal and, optionally, an image stream from the dialogue scene. The terminal converts the analog voice signal into a digital audio stream by sampling (for example, 16 kHz, 16-bit PCM) and stores the samples in a buffer in memory. The terminal segments the continuous audio stream into fixed-length frames and computes audio level to detect whether speech is present. The output is a series of digital audio frames tagged with timestamps and a session identifier.

### Step 2:

The terminal prepares audio packets and sends them to the server.

The input is the series of digital audio frames and session metadata (session ID, terminal ID, timestamps). The terminal compresses the audio frames into an encoded format (for example, Opus or FLAC) and groups multiple encoded frames into a packet. The terminal generates a network request, attaches the encoded audio as a payload, adds headers including the session ID and user identifier, and transmits the packet to the server via a secure protocol such as HTTPS. The output is a sequence of network packets containing encoded audio and metadata transmitted to the server.

### Step 3:

The server receives the audio packets and reconstructs the audio stream.

The input is the sequence of network packets received from the terminal. The server validates each packet (for example, by checking authentication tokens, content type, and session ID), extracts the encoded audio payload, and decodes it back into digital audio samples using an audio codec library. The server concatenates the decoded audio samples in time order for each session, thereby reconstructing a continuous digital audio stream. The output is a reconstructed digital audio stream per session, stored in memory or temporary storage, and associated with session metadata.

### Step 4:

The server performs speech recognition and generates character information.

The input is the reconstructed digital audio stream per session. The server computes acoustic feature information such as Mel-frequency cepstral coefficients or log-mel filter bank energies by applying a short-time Fourier transform and filter bank operations to overlapping audio frames. The server feeds the acoustic feature sequences into a speech recognition model, for example, a neural network-based automatic speech recognition engine. The engine applies matrix multiplications and non-linear activation functions through multiple layers and decodes the output into text sequences using a decoding algorithm such as beam search with a language model. The output is character information, i.e., transcribed text for each detected utterance, along with recognition confidence scores and time boundaries.

### Step 5:

The server constructs dialogue history information.

The input is the character information and associated metadata (speaker label if known, timestamps, confidence scores). The server segments the text into utterance units, assigns a speaker label (user or dialogue partner) based on channel or device information, and creates an utterance record data structure containing at least text, start time, end time, and confidence. The server appends each utterance record in chronological order to a dialogue history object maintained for the session. The output is dialogue history information represented as a structured collection (for example, a list or database table) of utterance records indexed by session ID.

### Step 6:

The server detects a timing for analysis and extracts a context window.

The input is the updated dialogue history information. The server monitors the arrival of new utterances and determines that a customer utterance has completed based on silence duration or explicit markers. The server then extracts a context window from the dialogue history, for example, the last N utterances or all utterances within a predefined time span. The server concatenates text fields from the selected utterances, preserving the order and speaker labels, into a context text string. The output is a context window object that includes a context text string, a list of included utterances, and associated metadata.

### Step 7:

The server identifies key phrases related to demand and preference information.

The input is the context text string from the context window. The server performs natural language processing on the context text using algorithms such as tokenization, part-of-speech tagging, and keyword extraction. The server may apply a statistical keyword extraction method or a small neural classifier to detect phrases related to needs (for example, “high in protein,” “low sugar,” “for sensitive skin”) and preferences (for example, “not too expensive,” “eco-friendly,” “compact size”). The server groups detected phrases into demand-related and preference-related categories and removes duplicates. The output is a set of key phrases, each tagged as demand information or preference information.

### Step 8:

The server generates a prompt sentence for the generative AI model.

The input is the context text string, the set of key phrases, and the predetermined theme. The server constructs a prompt sentence by embedding these elements into a template. The server inserts the theme, the recent conversation as quoted text labeled by speaker, and an explicit section emphasizing key phrases, for example: “Key customer need: healthy food, high in protein, low in sugar.” The server appends an instruction specifying the required output format (for example, “identify the customer's main needs and preferences in 2 sentences, and suggest 5 product category ideas and one follow-up question”). The output is a structured prompt sentence represented as a text string ready to be provided as input to the generative AI model.

### Step 9:

The server calls the generative AI model with the prompt sentence and context.

The input is the prompt sentence and, optionally, additional dialogue history information. The server sends the text as part of a request body to the generative AI model execution environment. Inside the environment, the text is tokenized into subword tokens, and the generative model, implemented as a transformer network, processes the tokens through multiple self-attention and feed-forward layers. The model computes hidden representations for each token and then generates output tokens by sampling or selecting from the predicted token distribution at each decoding step. The output is a generated analysis text, which includes inferred demand information, inferred preference information, recommended product categories, and suggested follow-up questions, returned to the server as a text string.

### Step 10:

The server parses the analysis text and structures the analysis result.

The input is the generated analysis text from the generative AI model. The server applies text parsing rules or lightweight natural language processing to segment the analysis text into logical components, such as “needs summary,” “preferences summary,” and “recommended categories.” The server detects category names and attributes using dictionaries or pattern matching and converts them into structured fields in a data record. The server thus produces an analysis result object that explicitly contains demand information fields, preference information fields, and a list of recommended category labels. The output is the structured analysis result object associated with the current session.

### Step 11:

The server searches candidate information items based on the analysis result.

The input is the analysis result object and the merchandise/service information stored in databases. The server converts the demand and preference fields into a query representation, such as attribute filters and a semantic embedding vector. The server executes database queries that filter records by category, price range, or other attributes, and then calculates similarity scores between the embedding of inferred needs and precomputed embeddings of items. The server may use vector operations to compute cosine similarity or inner products. The output is a list of candidate information items, each with an associated relevance score.

### Step 12:

The server ranks and selects candidate information items.

The input is the list of candidate information items with relevance scores and additional item metadata such as promotion status and availability. The server applies a scoring function that combines relevance with other factors, for example, f(item)=α·relevance+β·promotion+γ·availability. The server sorts the items in descending order of the score and truncates the list to a fixed number of top items suitable for display. The output is a ranked subset of candidate information items, each containing identifiers, names, and key attributes.

### Step 13:

The server formats display information for the terminal.

The input is the ranked subset of candidate information items and, optionally, the summarized needs and preferences from the analysis result. The server generates short text descriptions that link each item to the detected needs (for example, “High-protein, low-sugar yogurt suitable for health-conscious customers”). The server enforces character limits, inserts line breaks, and orders items by priority to fit the display constraints of the terminal. The server also optionally generates a suggested follow-up question as a separate short text. The output is display information, including multiple small text blocks and an optional question, structured for transmission to the terminal.

### Step 14:

The terminal receives and renders the display information.

The input is the display information received from the server as a response message. The terminal parses the message, extracts the text blocks, and maps them to display regions in the visual display device. The terminal updates the on-screen overlay, removing obsolete content and drawing the new content using appropriate font size and contrast for readability. The output is a rendered visual overlay that shows, to the user, recommended items and suggested phrases while the user continues interacting with the dialogue partner.

### Step 15:

The user uses the displayed information to adjust real-time interaction.

The input is the visual overlay content on the terminal's display and the ongoing conversation with the dialogue partner. The user reads the recommendations and suggested questions and then adapts their spoken response, for example, by proposing one of the suggested items or asking the recommended follow-up question. The output is an adjusted spoken utterance that reflects both the user's own judgment and the assistance provided by the system, which in turn becomes new audio input to the terminal, thereby continuing the processing cycle.

### Step 16:

The server generates a persona report after session completion.

The input is the full dialogue history information and accumulated analysis results for the session, triggered when the session is marked as ended by the user or by timeout. The server compiles the dialogue history into a transcript text and prepares a second prompt sentence that instructs the generative AI model to create a persona report, including sections such as main interests, lifestyle, product preferences, and service tips. The server sends this prompt sentence and the transcript to the generative AI model, receives the generated report text, and structures it into a report record with labeled sections. The output is report information that encapsulates the persona and characteristics of the dialogue partner, stored in a storage device for later retrieval.

### Step 17:

The server outputs stored report information for later customer service activities.

The input is a retrieval request from a terminal (for example, a tablet, PC, or the same wearable terminal) that includes a session identifier or a customer identifier. The server queries the storage device, retrieves the corresponding report information, and optionally converts it into a format optimized for display, such as concise bullet points. The server sends this formatted report information to the requesting terminal. The output is a human-readable summary of past dialogue and inferred characteristics, which can be displayed on the terminal and referenced by the user to prepare for a subsequent interaction with the same or a similar dialogue partner.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented candidate evaluation systems primarily rely on static document screening and simple keyword or rule-based text analysis. Such systems typically process application documents as unstructured text without performing sufficiently robust normalization, segmentation, and structured analysis, and therefore fail to exploit the full expressive content of free-form responses written by examinees. As a result, the underlying computing infrastructure tends to treat rich narrative responses as opaque strings, leading to (i) limited machine interpretability, (ii) difficulty in extracting consistent, comparable evaluation metrics, and (iii) high manual workload on human reviewers.

Furthermore, known systems that integrate machine learning often invoke a generative artificial intelligence model in an ad hoc manner. In these systems, prompt sentences sent to the generative model are manually crafted, inconsistent across evaluations, and not systematically updated based on feedback. This causes instability in model outputs, lack of reproducibility, and poor alignment between the model's behavior and the evaluation policy defined by a recruiting organization. From a computer technology perspective, the interaction between the application server and the generative model is not optimized as a structured, feedback-driven pipeline, and the system does not manage model inputs and outputs as typed, validated data structures.

In addition, many existing systems simply display the raw responses generated by a generative model as unstructured text to a user interface. Such systems do not verify that returned data conforms to a predetermined format or numeric range, nor do they transform the model output into structured records that can be readily indexed, aggregated, or visualized by downstream components. This leads to fragile integrations, frequent parsing errors, and inconsistent reporting across examinees, degrading the reliability and scalability of the overall computing system.

There is also a lack of mechanisms for the computing system to incorporate user feedback into the generation of subsequent prompts and evaluation policies. Without a structured feedback loop, the system cannot systematically refine prompt construction or adjust evaluation criteria at the level of machine-readable parameters. As a consequence, the system cannot adapt its model interaction layer to changing organizational needs or discovered biases in model outputs, and thus cannot improve the quality of its computing operations over time.

Accordingly, there is a need for an improved computer-implemented system and server architecture that (i) programmatically preprocesses examinee response text into a normalized, model-friendly format, (ii) generates structured, policy-based prompt sentences targeting specific abilities or characteristics, (iii) validates and structures generative model outputs into consistent evaluation records, and (iv) applies user feedback to dynamically update prompt contents and evaluation policies. Such a system should enhance the reliability, controllability, and efficiency of the interaction between the server and the generative AI model, improve the quality and stability of the analysis pipeline, and thereby provide a concrete improvement in computer technology for automated candidate evaluation and report generation.

The specific processing by the specific processing unit 290 of the data processing device 12 in Example 2 is realized by the following means.

The present invention provides a server comprising a processor and a storage device, the processor being configured to collect, via an information input device, response information from an examinee regarding a predetermined task and store the response information in the storage device, perform text preprocessing on the stored response information, the text preprocessing including at least character normalization, removal of unnecessary whitespace and control characters, and segmentation into sentences and words, thereby converting the response information into a normalized format analyzable by a generative AI model, generate, together with the preprocessed response information, a prompt sentence in a natural language that defines an evaluation policy for at least one of an ability or a characteristic of the examinee, the prompt sentence being constructed in a structured and reproducible manner and transmitted from the server to the generative AI model, receive an analysis result from the generative AI model in response to the prompt sentence, parse and validate the analysis result against a predetermined data format or value range, convert the validated analysis result into structured evaluation data including at least a numerical evaluation item, a classification label, and explanatory text, store, in the storage device, evaluation information for each examinee including an ability index, a behavioral characteristic, and a text portion serving as supporting evidence, aggregate the evaluation information to generate a report document regarding a characteristic and a latent ability of the examinee, format the report document as display data outputtable to a display device, and acquire user feedback regarding the report document and dynamically update at least one of contents of the prompt sentence or the evaluation policy based on the user feedback so as to refine subsequent interactions with the generative AI model. This enables the computing system to implement a robust, feedback-driven pipeline that standardizes text preprocessing, stabilizes and structures interactions with the generative AI model via policy-based prompt sentences, enforces validation of model outputs, and iteratively improves the evaluation logic based on user feedback, thereby enhancing the reliability, scalability, and technical performance of computer-implemented candidate evaluation and reporting.

The term “response information” refers to text data or equivalent symbolic data representing answers, essays, questionnaires, or other free-form or semi-structured responses provided by an examinee in relation to a predetermined task.

The term “examinee” refers to an individual subject whose abilities, characteristics, or other traits are to be evaluated by the system based on response information.

The term “predetermined task” refers to an assignment, question, scenario, or topic specified in advance, for which the examinee is requested to provide response information.

The term “information input device” refers to any hardware or software interface through which response information is entered into the system, including but not limited to client terminals, input forms, application programming interfaces, or file upload interfaces.

The term “storage device” refers to any physical or logical data storage component capable of persistently storing digital information, including but not limited to semiconductor memory, magnetic storage, optical storage, or networked storage services.

The term “text preprocessing” refers to a series of computational operations applied to response information to normalize and structure the text, including but not limited to character normalization, removal of unnecessary whitespace and control characters, and segmentation into sentences and words.

The term “character normalization” refers to a process of converting characters in response information into a unified representation, such as standardizing encodings, normalizing diacritical marks, or mapping visually similar characters to a canonical form.

The term “segmentation into sentences and words” refers to a process of dividing a text sequence into smaller linguistic units, including the detection of sentence boundaries and the identification of word or token boundaries.

The term “generative AI model” refers to a computational model that generates or transforms text or equivalent symbolic data based on input data and a prompt sentence, including but not limited to large language models or other generative machine learning models.

The term “normalized format analyzable by a generative AI model” refers to a representation of response information that has been preprocessed to remove noise and to conform to structural or length constraints suitable for reliable input to a generative AI model.

The term “prompt sentence” refers to a natural-language or functionally equivalent instruction sequence provided as input to a generative AI model, specifying an analysis task, evaluation criteria, output format, or other model behavior.

The term “evaluation policy” refers to a set of rules, criteria, or guidelines defining how the generative AI model is to assess at least one ability or characteristic of an examinee, including scoring scales, target traits, and required explanation formats.

The term “ability” refers to a capability or skill of an examinee, such as problem-solving ability, communication ability, or leadership ability, that is subject to evaluation by the system.

The term “characteristic” refers to a trait, tendency, or behavioral pattern of an examinee, such as collaborative behavior or communication style, that is subject to qualitative or quantitative assessment.

The term “analysis result” refers to output data produced by the generative AI model in response to a prompt sentence, including but not limited to scores, labels, summaries, rationales, and quoted evidence.

The term “structured evaluation data” refers to evaluation-related information that is stored in a defined data structure, such as key-value pairs, records, or objects, enabling consistent indexing, querying, and aggregation by the system.

The term “ability index” refers to a numerical or categorical indicator representing the level or degree of a particular ability of an examinee, derived from the analysis result of the generative AI model.

The term “behavioral characteristic” refers to a description or categorization of how an examinee tends to act or respond in certain contexts, as inferred from response information and analysis results.

The term “text portion serving as supporting evidence” refers to a segment of response information, such as a sentence or phrase, identified by the system or the generative AI model as justifying or illustrating a particular evaluation.

The term “evaluation information” refers to a collection of structured evaluation data for an examinee, including at least an ability index, a behavioral characteristic, and supporting text portions.

The term “report document” refers to a composed document, which may be in a digital format, that summarizes and presents evaluation information regarding characteristics and latent abilities of an examinee.

The term “display data” refers to data formatted for visual rendering on a display device, including layout, labels, and values suitable for presentation in graphical user interfaces or documents.

The term “display device” refers to any hardware component capable of visually presenting display data, including but not limited to monitors, tablets, smartphones, or projection systems.

The term “user feedback” refers to information provided by a user regarding the adequacy, correctness, or usefulness of a report document or evaluation information, including explicit ratings, comments, corrections, or confirmations.

The term “dynamically update” refers to a process in which the system modifies at least one of the contents of the prompt sentence or the evaluation policy during operation, based on newly acquired user feedback, without requiring redeployment of the entire system.

The term “target of evaluation” refers to a specific ability, characteristic, or behavior of an examinee, such as problem-solving ability or communication style, which the generative AI model is instructed to analyze.

The term “separate prompt sentences for respective evaluation targets” refers to individually constructed prompt sentences, each dedicated to eliciting an analysis of a distinct ability or characteristic of an examinee.

The term “analysis request” refers to an instruction, embodied in a prompt sentence or equivalent data, that directs the generative AI model to perform a particular type of evaluation or analysis.

The term “predetermined data format” refers to an expected structural arrangement of analysis results, such as a particular JSON schema or field layout, against which returned model outputs are validated.

The term “predetermined value range” refers to defined numeric or categorical constraints on portions of the analysis result, such as permissible score ranges or allowed label sets.

The term “evaluation record” refers to a unit of structured data representing the outcome of an evaluation for at least one ability or characteristic, including a numerical evaluation item, a classification label, and explanatory text.

The term “numerical evaluation item” refers to a value expressed as a number, such as a score or rating, representing the evaluated level of a particular ability or characteristic.

The term “classification label” refers to a symbolic value or category name, such as “high,” “medium,” “low,” or a predefined class, assigned to characterize an aspect of an examinee based on the analysis result.

The term “explanatory text” refers to narrative or descriptive content that explains or justifies a particular numerical evaluation item or classification label.

The term “processor” refers to one or more hardware processing units configured to execute instructions, including but not limited to central processing units, graphics processing units, or specialized accelerators, that implement the functions of the server.

In one embodiment, a server implements the claimed system as a network-accessible application that cooperates with a terminal operated by a user. The server includes at least one processor, a main memory, a non-volatile storage device, a network interface, and a display device or a display interface. The terminal includes at least one processor, a memory, an input device, and a display device, and executes a web browser or a dedicated client application.

The server executes an operating system, such as a general-purpose operating system, and application middleware including a web server, an application server, and a database management system. The server further executes a natural language processing framework and a generative AI model execution environment. The generative AI model is, for example, a multi-layer neural network configured to receive tokenized text and to output structured text or token sequences that can be parsed into evaluation results.

The server stores program modules in the storage device. These program modules include a data ingestion module, a text preprocessing module, a prompt generation module, a model interaction module, an output validation and structuring module, a report generation module, and a feedback-based adaptation module. The processor loads these modules into memory and executes them as needed.

The server receives response information from the terminal. The response information is supplied by the user, who acts as an operator representing an organization that evaluates examinees. The user uses the terminal to access a web page or client interface provided by the server, and selects files containing free-form text responses such as essays or questionnaires. The terminal transmits these files to the server over a secure communication channel.

The server converts the received files into plain text. The server uses a text extraction component that operates on various document formats and converts them to a unified character encoding. The server stores both the original files and the extracted text in the storage device, together with metadata such as examinee identifiers, timestamps, and document types.

The server executes text preprocessing on the stored response information. The server normalizes character encodings and applies character normalization operations, such as mapping multiple visually similar characters to canonical characters, and unifying line endings. The server removes unnecessary whitespace and control characters using deterministic algorithms configured with regular expressions and character-class filters. The server segments the text into sentences and words using a natural language processing library and a language-specific sentence boundary detection algorithm. The segmentation algorithm uses punctuation patterns and statistical language models to detect sentence boundaries, and tokenization rules to identify word boundaries. The server stores both the original text and the preprocessed text, along with segmentation indices, in the storage device.

The server generates at least one prompt sentence for the generative AI model. The server retrieves the preprocessed text and relevant metadata from the storage device. The server constructs a prompt sentence as natural-language text that encodes an evaluation policy. The server does not rely on manually crafted ad hoc prompts; instead, the server uses a rule-based prompt template engine. The prompt template engine applies a set of rules defined as parameterized patterns, which specify evaluation targets, scoring scales, output structure, and required evidence. The server populates these templates with the particular examinee's preprocessed text and evaluation parameters, such as required abilities and output formats.

For example, the server generates a prompt sentence as follows: “You are an evaluator that must analyze an examinee's essay. Read the following text and evaluate the examinee's problem-solving ability on a scale from 1 to 5, where 1 is very low and 5 is very high. Provide: (1) a single integer score, (2) a short summary of the examinee's problem-solving behavior, and (3) two to five short quotes from the text that justify your evaluation. Output your answer in the following fixed pattern: ‘Score: [number]’, ‘Summary: [text]’, ‘Evidence: [bullet list]’. Text: [PREPROCESSED_TEXT].”

In another example, the server generates a prompt sentence:

“Analyze the following essay and evaluate the examinee's leadership behavior, collaborative behavior, and communication style. For each of these three aspects, provide a label chosen from {high, medium, low} and a two-sentence explanation. At the end, provide a one-paragraph overall assessment tailored for a recruiter. Use only English in your response. Essay: [PREPROCESSED_TEXT].”

In still another example, the server uses user feedback to refine the prompt sentence: “In previous evaluations you tended to give overly high scores. For this task, be stricter and use the full range from 1 to 5. Evaluate the examinee's problem-solving ability based on concrete actions, handling of obstacles, and reflection on outcomes. Penalize vague statements that do not describe specific behaviors. Text: [PREPROCESSED_TEXT].”

The server transmits each prompt sentence and the associated text to the generative AI model. The generative AI model is implemented as a neural network, such as a transformer-based language model with multiple attention layers, feed-forward layers, and layer normalization. The model receives as input a sequence of tokens generated from the prompt sentence and the preprocessed text by a tokenizer. The tokenizer converts characters and words into token identifiers based on a learned vocabulary. The model processes the token sequence through multiple layers, each computing attention scores between tokens and updating hidden state vectors according to learned weight matrices.

The server configures the generative AI model with specific inference parameters, such as a maximum number of output tokens, a temperature parameter that controls sampling randomness, and a top-k or top-p sampling threshold. The server executes the model on a hardware platform that includes a graphics processing unit or an equivalent accelerator, which reduces inference time by parallelizing matrix multiplications in the attention and feed-forward layers. The server thereby improves processing speed and throughput compared to a purely central processing unit implementation.

The server receives an analysis result from the generative AI model. The analysis result is a sequence of tokens that the server decodes into text. The server applies an output validation and structuring algorithm. The server first checks whether the analysis result conforms to the expected pattern or structure defined in the prompt sentence. For example, the server parses the text to ensure that it includes a “Score:” line with a valid integer in a defined range, a “Summary:” line, and an “Evidence:” section. The server performs this validation using a deterministic parser configured with regular expressions and grammar rules that match the specified output pattern.

The server converts the validated analysis result into structured evaluation data. The server stores the numerical score as an ability index in a numeric field, stores labels such as “high,” “medium,” or “low” as classification labels, and stores explanation text and evidence sentences as separate text fields. The server stores these records in the storage device in a normalized schema, where each evaluation record is associated with an examinee identifier, a document identifier, and a timestamp. By enforcing these typed data structures, the server improves data integrity and enables efficient indexing and querying by downstream components.

The server aggregates evaluation information for each examinee. The server combines scores and labels for multiple abilities or characteristics, such as problem-solving ability, leadership behavior, collaborative behavior, and communication style. The server computes additional derived metrics, such as averaged scores or weighted composite indices. The server generates a report document that includes these aggregated metrics, narrative explanations, and excerpts from the response information that serve as supporting evidence.

The server formats the report document as display data suitable for the display device. The server converts the structured evaluation data into a representation usable by a web-based dashboard or a document renderer. The server may generate markup that includes tables, charts, and sections of explanatory text. The server transmits this display data to the terminal over a network connection.

The terminal receives the display data and renders it on the display device. The terminal may render interactive graphical elements, such as charts showing ability indices or expandable sections containing evidence excerpts. The user can visually inspect the evaluation results, compare multiple examinees, and understand how each score is supported by specific portions of the response information.

The user may provide feedback to the server. The user may indicate agreement or disagreement with particular evaluation records, adjust scores, or enter comments. The terminal captures this feedback and sends it to the server. The server stores the feedback in association with the underlying evaluation records and the corresponding prompt sentences.

The server applies the stored feedback to adjust future prompt generation and evaluation policies. For example, if user feedback indicates that scores are systematically too high, the server changes parameters in the prompt generation module to instruct the generative AI model to be stricter. The server can also adjust the evaluation criteria by altering the weight given to specific behavioral indicators. The server may maintain a feedback profile that records systematic biases or desired calibration changes and injects corresponding instructions into future prompt sentences.

The server thereby improves computer technology in several ways. First, the server improves processing speed and scalability by offloading computationally intensive neural network inference to specialized hardware and by normalizing and structuring text before model invocation, which reduces unnecessary token length and model overhead. Second, the server improves accuracy and consistency by defining explicit evaluation policies in machine-readable prompt templates and by enforcing strict output validation and structured storage, which reduces parsing errors and inconsistent formats. Third, the server improves data management by storing both raw and preprocessed text, segmentation indices, and structured evaluation records in a normalized schema, enabling efficient retrieval, aggregation, and visualization.

The server also applies non-conventional processing steps that differ from merely automating human review. Human evaluators typically read text holistically and assign subjective scores without explicit structured templates or validation against deterministic schemas. By contrast, the server constructs prompt sentences according to a predefined template-driven engine, enforces specific output formats, and uses deterministic parsers to convert model outputs into structured records. The server thus imposes a rule-based interface between the generative AI model and the data storage system, which enables automated verification, error handling, and feedback-based adaptation that are not feasible in purely manual processes.

The server further applies technical mechanisms inside the generative AI pipeline. For example, the server can regulate the model's behavior by setting temperature to a low value when deterministic outputs are desired, thereby reducing variance and improving reproducibility. The server can apply a top-k or top-p sampling threshold to control output diversity and to minimize anomalous outputs that do not match the evaluation policy. The server can also perform length control by truncating or summarizing long input texts using separate neural summarization components, thereby reducing input token count, lowering computation cost, and decreasing latency.

In another embodiment, the server deploys a generative AI model that is fine-tuned on domain-specific evaluation data. The server initially trains the neural network using a training set that includes example essays and ground-truth evaluation labels. During training, the server computes a loss function, such as a cross-entropy loss between model-predicted tokens and reference tokens that encode correct scores and justifications. The server updates model parameters using an optimization algorithm, such as stochastic gradient descent with momentum or an adaptive method, to minimize the loss function. The server may use data augmentation techniques, such as paraphrasing or noise injection into training sentences, to improve generalization and robustness. By performing this training, the server configures the generative AI model to produce outputs aligned with the system's evaluation policy and to be more stable under small variations in input text.

In a further embodiment, the server executes multiple generative AI models or multiple configurations of a single model and aggregates their outputs. The server may request independent evaluations from different model instances and use an ensemble method, such as voting or weighted averaging, to derive a final score. The server stores confidence scores based on agreement between models and may flag low-confidence cases for human review. This approach reduces the risk of outlier predictions and enhances the overall reliability of the system.

In another variant, the server compresses or indexes structured evaluation records for efficient retrieval. The server may create inverted indices for classification labels and ability indices, enabling fast queries over large populations of examinees. The server may generate precomputed aggregates for reporting dashboards, such as distributions of scores across populations. These optimization techniques improve query response time and reduce processing load on the database.

The server also reduces communication load between the server and the generative AI model execution environment. By normalizing and compressing input text, filtering out irrelevant sections, and summarizing long documents before passing them to the model, the server reduces the number of tokens that must be transmitted and processed. The server may batch multiple evaluation requests into a single model invocation, further decreasing overhead per examinee and increasing throughput.

The terminal and the user remain decoupled from low-level model and data management. The terminal simply sends response information and displays results, while the server handles normalization, prompt generation, model interaction, validation, structuring, and feedback integration. This separation allows the server to implement complex internal algorithms and data structures without increasing client-side complexity, leading to a more robust and maintainable overall system.

Multiple alternative embodiments are possible. In one embodiment, the server deploys an on-premises generative AI model, while in another, the server accesses a remote model through an application programming interface provided by an external provider. In one embodiment, the server uses a single language model; in another, the server uses different models for different languages or domains. In one embodiment, the server provides reports as web pages; in another, the server generates print-ready documents or machine-readable export files. In each case, the core mechanism remains: the server preprocesses response information, constructs policy-based prompt sentences, interacts with a generative AI model under controlled parameters, validates and structures outputs, and adapts subsequent processing based on user feedback, to achieve technical improvements in computing performance, accuracy, and data handling.

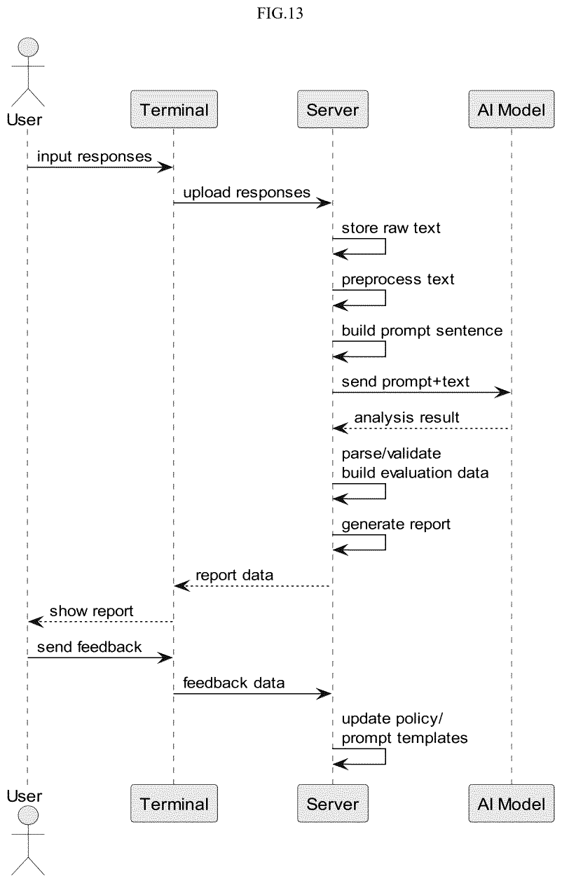

The following describes the processing flow using FIG. 13.

### Step 1:

Server receives response information from terminal and stores it.

Server receives, as input, one or more files or text fields that the terminal uploads, the files containing response information such as essays or questionnaire answers related to a predetermined task. Server accepts this input via a network interface, using a web API endpoint. Server extracts text from the input using a text extraction component, converts the text to a unified character encoding, and assigns identifiers such as examinee IDs and document IDs. Server writes, as output, raw text data and associated metadata into a storage device, for example into relational tables with fields for examinee ID, document ID, timestamp, and original file path.

Terminal sends the response information to server.

Terminal receives, as input, file selections or typed text from user through a graphical user interface. Terminal packages the selected files or text into an HTTP request and transmits the request over a secure channel to server. Terminal displays, as output, an upload status message based on server's response.

User submits response information for each examinee.

User selects, as input, one or more files or pastes text into an input area on terminal. User reviews the selection and activates a submission control. User observes, as output, a confirmation that the data has been sent and stored by server.

### Step 2:

Server performs text normalization and cleaning.

Server reads, as input, the stored raw text and metadata from the storage device for a particular document ID. Server applies character normalization, including mapping characters to canonical forms and converting line endings to a standard representation. Server removes unnecessary whitespace, tab characters, and control characters using pattern-matching operations, and strips any markup tags if present. Server generates, as output, a cleaned text string and updated metadata, and writes them into a dedicated field such as “cleaned_text” in the storage device.

### Step 3:

Server performs segmentation into sentences and words.

Server receives, as input, the cleaned text for a document from the storage device. Server applies a natural language processing library that executes a sentence boundary detection algorithm and a tokenization algorithm. Server computes sentence boundaries by scanning for punctuation patterns and using probabilistic models to disambiguate boundary candidates, then splits each sentence into tokens based on whitespace and language-specific token rules. Server produces, as output, a sentence list and a token list with positional indices, and stores these lists as structured records, for example as JSON or as normalized tables linking each token to a sentence ID and character offsets.

### Step 4:

Server constructs a prompt sentence based on evaluation policy.

Server retrieves, as input, the preprocessed text (cleaned text and segmentation data) and configuration parameters describing which abilities or characteristics must be evaluated, such as problem-solving ability or leadership behavior. Server uses a template-based prompt generation engine that combines fixed template strings with variable portions, including evaluation targets, scoring scales, required output format, and the examinee's text. Server concatenates these elements into a single prompt sentence or into multiple prompt sentences when distinct evaluation targets are specified. Server outputs one or more complete prompt sentences and associates them with the corresponding document ID and evaluation targets in the storage device.

### Step 5:

Server sends prompt sentence and preprocessed text to generative AI model and executes inference.

Server reads, as input, a constructed prompt sentence and any attached preprocessed text from the storage device. Server tokenizes the combined prompt and text using a tokenizer associated with the generative AI model, converting characters and words into token identifiers. Server transmits the token sequence and inference parameters, such as temperature, maximum output length, and sampling thresholds, to the generative AI model running on a model execution environment. The model execution environment computes, layer by layer, attention weights and hidden state vectors using stored weight matrices, and generates, as output, a sequence of output tokens. Server decodes the token sequence into text and stores the resulting analysis result text, along with model parameters used, into the storage device.

### Step 6:

Server validates and parses the analysis result into structured evaluation data.

Server retrieves, as input, the analysis result text produced by the generative AI model for a particular prompt sentence. Server applies a deterministic parser configured with pattern-matching rules or a simple grammar consistent with the output format specified in the prompt sentence. Server checks that required elements such as scores, labels, summaries, and evidence items are present, and that numerical scores fall within predefined ranges. If the analysis result satisfies the constraints, server extracts values and converts them into typed fields, such as integer scores, categorical labels, and explanatory text segments. Server writes, as output, structured evaluation data records into the storage device, linking each record to an examinee ID, document ID, and evaluation target.

### Step 7:

Server generates and formats a report document.

Server acquires, as input, structured evaluation records for one examinee, including ability indices, behavioral characteristics, and supporting text portions. Server aggregates these records by computing derived metrics, such as averages or composite indices, and arranging evaluation items into a logical structure. Server inserts numeric values, labels, and explanation text into a report template, which may include sections for summary, detailed evaluations, and evidence excerpts. Server produces, as output, a report document representation and corresponding display data, such as structured markup or serialized objects, and stores them in the storage device or prepares them for immediate transmission.

### Step 8:

Server transmits display data to terminal for visualization.

Server reads, as input, the display-ready report data generated for an examinee. Server wraps the report data into a response message, such as an HTTP response containing structured content and optional style information. Server sends this response over the network to terminal. Server outputs, as a result, a data stream that terminal can render as a user interface.

Terminal renders and presents the report to user.

Terminal receives, as input, the display data from server. Terminal parses the structured content and renders graphical components, such as tables of scores, labeled sections of text, and potentially charts that visualize ability indices. Terminal outputs the rendered user interface on the display device, enabling scrolling, selection, and comparison interactions.

User reviews evaluation information and provides feedback.

User takes, as input, the visualized report on terminal and reads scores, labels, summaries, and supporting evidence segments. User may enter feedback, such as confirming correctness, indicating overestimation or underestimation, or entering free-form comments. User submits this feedback through interface elements on terminal, which sends the feedback to server.

### Step 9:

Server records feedback and updates prompt generation and evaluation policy.

Server receives, as input, user feedback records associated with specific evaluation items and reports. Server stores the feedback in a feedback data structure tied to the original evaluation records and prompt sentences. Server analyzes the accumulated feedback, for example by computing statistics on systematic deviations between AI-generated scores and user adjustments, or by identifying frequent comments indicating a particular bias. Based on this analysis, server adjusts parameters of the prompt generation templates or evaluation policy, such as changing threshold descriptions, altering instructions to be stricter or more conservative, or modifying the requested output format. Server outputs updated prompt template parameters and policy rules, which are stored in the storage device and used in subsequent executions of Step 4 and Step 5, thereby altering future prompt sentences and improving the alignment and stability of the generative AI model's outputs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented assessment systems for recruitment and security screening typically process text responses or simple questionnaire data in isolation. These systems often rely on fixed rule sets or static scoring tables executed by general-purpose processors. As a result, such systems are limited in their ability to capture complex relationships between dialogue content, behavioral context, and emotional state of an evaluation target. In particular, conventional systems do not dynamically adapt their analysis flow or model input based on incoming multi-modal data, and therefore cannot fully exploit modern generative AI models in a systematic and machine-efficient way.

Further, although generative AI models can produce rich narrative evaluations, existing integrations usually treat these models as black-box text generators. The models are generally prompted in an ad hoc manner by human operators, and the resulting free-form text is presented directly to users without being converted into structured machine-readable indices. This causes several technical problems: it becomes difficult for a processor to automatically aggregate results across sessions, difficult to compute consistent risk levels, and difficult to trigger real-time warnings. The computing system therefore fails to provide stable latency, predictable resource usage, or consistent evaluation quality when handling many evaluation targets in parallel.

Moreover, conventional emotion recognition modules and language analysis modules are often implemented as separate subsystems, with no unified control logic at the processor level. Emotion recognition results may be displayed as auxiliary information to a human operator, but they are not systematically fused with dialogue analysis outputs inside a common data model. Because of this separation, the processor cannot compute integrated evaluation indices that combine traits, abilities, and emotional changes, and the overall system cannot automatically adjust risk thresholds or reporting granularity in response to changing emotional states. This siloed architecture degrades the efficiency, responsiveness, and robustness of the computer system as a whole.

Still further, existing systems do not provide a standardized mechanism for dynamically generating prompt sentences tailored to the current context, such as question type, past answers, and stored evaluation history. As a result, the processor cannot automatically refine unclear items detected during document screening, cannot enforce structured output formats from the generative AI model, and cannot guarantee that each inference cycle produces data suitable for downstream computation. This lack of prompt control leads to increased post-processing overhead, inconsistent data structures, and unnecessary use of computing resources when re-prompting or manually correcting outputs.

Accordingly, there is a need for an improved computer-implemented system that coordinates a generative AI model and an emotion recognition model under unified processor control, dynamically generates context-aware prompt sentences, enforces structured output formats, and computes integrated evaluation and risk indices in real time. Such a system should improve the technical functioning of the underlying computer architecture, including data flow management, resource utilization, latency characteristics, and reliability of automated decision support in recruitment and security scenarios.

The specific processing by the specific processing unit 290 of the data processing device 12 in Application Example 2 is realized by the following means.

The present invention provides a server comprising a processor configured to conduct a dialogue between an evaluation target and a generative AI model regarding a predetermined theme, to analyze a content of the dialogue using the generative AI model, to acquire speech information and image information of the evaluation target and estimate an emotional state and a temporal change of the emotional state of the evaluation target by analyzing the speech information and the image information using an emotion recognition model, to numerically calculate an ability index and a trait index of the evaluation target based on an analysis result of the dialogue content by the generative AI model and compute an integrated evaluation index by associating the ability index and the trait index with the emotional state and the temporal change of the emotional state estimated by the emotion recognition model, to generate report data including descriptive information relating to traits, abilities, and emotional aspects of the evaluation target based on the integrated evaluation index by applying a document template and output the report data as document data, to receive, from a terminal device, answer data, behavior history data, or biometric information data, dynamically generate a prompt sentence for input to the generative AI model based on the received data, transmit the prompt sentence together with the received data to the generative AI model, calculate a risk level according to a predetermined threshold based on an analysis result output from the generative AI model and an emotion estimation result output from the emotion recognition model, generate warning information corresponding to the risk level, and transmit the report data and the warning information to the terminal device in real time while converting the report data and the warning information into a presentation format that is visually or auditorily presentable on the terminal device. This enables the computer system to orchestrate natural language analysis and emotion recognition under unified control, to systematically produce structured evaluation and risk indices from multi-modal input in real time, to reduce post-processing complexity and latency through prompt sentence management and format-constrained outputs, and to improve overall computational efficiency and reliability when performing automated assessment and risk evaluation for multiple evaluation targets.

The term “system” refers to an arrangement of one or more computing devices including at least one processor and associated hardware and software components that cooperate to execute the functions described in the claims.

The term “processor” refers to a hardware processing unit, such as a central processing unit or an execution core, configured to execute program instructions to perform logical operations, numerical computations, data communication control, and input/output control.

The term “evaluation target” refers to a person or subject whose traits, abilities, emotional state, or risk level are assessed by the system based on dialogue content, behavioral data, or biometric information.

The term “generative AI model” refers to a machine-implemented information processing model that receives input data including at least a prompt sentence and produces new text or structured outputs by probabilistic generation based on parameters learned from training data.

The term “dialogue” refers to an exchange of utterances, text messages, or other linguistic interactions between the evaluation target and the generative AI model under control of the processor.

The term “predetermined theme” refers to a topic or scenario defined in advance by configuration data or program logic, which constrains the content and purpose of the dialogue with the evaluation target.

The term “dialogue content” refers to textual data representing the utterances of the evaluation target and the responses of the generative AI model, including both single turns and multi-turn conversational histories.

The term “speech information” refers to audio data or features derived from audio data that represent the vocal expression of the evaluation target, including prosody, pitch, volume, and temporal characteristics.

The term “image information” refers to visual data or features derived from visual data that represent an appearance of the evaluation target, including facial expressions, head movements, and other observable features.

The term “emotion recognition model” refers to a machine-implemented model or software component configured to analyze speech information and/or image information to estimate an emotional state and changes of the emotional state of the evaluation target.

The term “emotional state” refers to a psychological condition of the evaluation target, represented by one or more categories such as joy, sadness, anger, fear, or neutrality, or by corresponding numerical scores.

The term “temporal change of the emotional state” refers to a variation of the estimated emotional state of the evaluation target over time during a dialogue or observation period.

The term “ability index” refers to a numerical value or set of values that quantitatively expresses one or more capabilities of the evaluation target, such as problem-solving ability or communication ability, computed from analysis results of the generative AI model.

The term “trait index” refers to a numerical value or set of values that quantitatively expresses one or more personality traits or behavioral tendencies of the evaluation target, computed from analysis results of the generative AI model.

The term “integrated evaluation index” refers to one or more composite values obtained by combining at least the ability index, the trait index, and the emotional state or temporal change of the emotional state to represent an overall evaluation of the evaluation target.

The term “report data” refers to structured digital data that describes traits, abilities, and emotional aspects of the evaluation target and that is generated by the processor to be rendered as a human-readable document.

The term “document template” refers to predefined layout data or formatting rules that specify positions, styles, and structures for inserting report data into a document.

The term “document data” refers to electronic document content, such as a file or data stream, that can be stored, transmitted, and displayed, and that contains at least part of the report data formatted according to the document template.

The term “terminal device” refers to an information processing device such as a client computer, mobile device, head-mounted display device, or other user interface device, configured to transmit data to the server and present outputs from the server.

The term “answer data” refers to textual information or equivalent digital representations of responses provided by the evaluation target to questions or prompts presented by the terminal device.

The term “behavior history data” refers to digital records representing past actions or events related to the evaluation target, such as past responses, interaction logs, or usage patterns, stored and processed by the system.

The term “biometric information data” refers to digital representations of inherent physical or behavioral characteristics of the evaluation target, including at least speech information, image information, or physiological signals.

The term “prompt sentence” refers to a text string or structured instruction generated by the processor and supplied to the generative AI model to specify an analysis task, required output format, or contextual information for the model.

The term “analysis result” refers to output data generated by the generative AI model based on the prompt sentence and input data, including at least evaluations of traits, abilities, or narrative explanations.

The term “emotion estimation result” refers to output data generated by the emotion recognition model, including estimated emotional states, temporal changes of the emotional states, and associated confidence values.

The term “risk level” refers to a quantitative or qualitative indicator representing a degree of potential risk associated with the evaluation target, computed by the processor based on the analysis result and the emotion estimation result.

The term “warning information” refers to notification data generated by the processor when the risk level satisfies a predetermined condition, the notification data indicating at least the presence or severity of a potential risk.

The term “real time” refers to processing and transmission performed with latency sufficiently small that the report data, risk level, or warning information is provided while the dialogue or observation of the evaluation target is ongoing.

The term “presentation format” refers to a representation of data, such as graphical, textual, or audio representation, that can be directly output through an output interface of the terminal device to a human user.

The term “storage device” refers to a memory component or storage subsystem, such as a non-volatile storage unit or database, that stores answer data, behavior history data, past evaluation results, or report data for later retrieval and processing.

The term “past evaluation results” refers to previously computed indices, reports, or other assessment outputs relating to the same evaluation target or related evaluation targets, stored in the storage device.

The term “additional prompt sentence” refers to a prompt sentence generated after an initial analysis, which is designed to cause the generative AI model to perform a further or more detailed analysis based on multiple pieces of answer data and past evaluation results.

The term “format specifying information” refers to instructions included in a prompt sentence that define a required output structure of the generative AI model, such as key names, data types, or serialization formats.

The term “structured data” refers to data organized according to a defined schema, including labeled fields such as evaluation indices, explanatory text, and supporting information, which can be programmatically parsed and processed by the processor.

The term “evaluation indices” refers to one or more numerical or categorical values representing specific aspects of the evaluation target's traits, abilities, or risks, derived from outputs of the generative AI model.

The term “explanatory text” refers to narrative or descriptive text generated by the generative AI model that explains or supports the evaluation indices.

The term “supporting information” refers to additional details, such as extracted evidence, key phrases, or reasoning steps, that substantiate the evaluation indices and are included in the structured data.

The term “risk index” refers to a numerical or categorical value within the structured data that quantifies or classifies a risk associated with the evaluation target, based on analysis by the generative AI model and on fusion with emotion-related information.

The term “multi-modal input” refers to a combination of two or more different types of input data, including at least linguistic data, audio data, and visual data, processed together by the system for analysis.

In one embodiment, server executes a program on a hardware platform comprising at least one processor, a main memory, a non-volatile storage device, and a network interface. Server runs an operating system such as a general-purpose server operating system and hosts application software modules including a dialogue management module, a generative AI interface module, an emotion recognition interface module, a fusion and scoring module, a report generation module, and a terminal communication module.

Server stores the program and model parameters in a storage device such as a magnetic disk, a solid-state drive, or a network-attached storage. Server loads executable instructions into main memory and performs computations using one or more processing units, which may include a central processing unit and an accelerator such as a graphics processing unit. Server uses an accelerator to execute matrix operations and tensor operations for neural network inference, thereby improving throughput and latency compared to a configuration using only a central processing unit.

Server cooperates with a generative AI model implemented as a neural network, for example a transformer-based sequence model having a plurality of encoder-decoder layers, multi-head self-attention mechanisms, and feed-forward sublayers. Server also cooperates with an emotion recognition model implemented as a convolutional neural network for image analysis and as a recurrent or transformer-based network for audio-feature analysis. Server may execute such neural networks using a deep learning framework such as a numerical computation library, and may store learned weights, bias parameters, and normalization parameters as arrays in the storage device.

Server maintains a data structure in memory that represents each evaluation session as an object including fields for a session identifier, a user identifier, a list of dialogue turns, a list of emotion observations, an ability index vector, a trait index vector, and a risk index. Server stores each dialogue turn as a record having fields for a turn index, a speaker identifier (evaluation target or model), a text string, a timestamp, and a reference to emotion observations. Server stores each emotion observation as a record containing a timestamp, a set of probability values over predefined emotion classes, and one or more continuous scores such as arousal and valence.

Server receives answer data, behavior history data, and biometric information data from terminal via a communication interface using a network protocol such as HTTP over a secure transport. Server stores incoming data in a buffer and normalizes formats, such as converting character encodings to a unified encoding, resampling audio signals to a standard sampling rate, and resizing image frames to a predetermined resolution suitable for the emotion recognition model.

Server generates a program for conducting the dialogue management and evaluation by composing functional modules with predetermined interfaces. Server associates a dialogue management module with a rule set stored in configuration data. The rule set specifies, for each predetermined theme and question type, how a prompt sentence is to be formed, what output format is to be requested from the generative AI model, and how the output is to be mapped into internal indices.

Server uses a generative AI model that has been trained on a large text corpus using a supervised pre-training method and, optionally, fine-tuning with task-specific data. During training, server minimizes an error function such as cross-entropy between predicted token distributions and target tokens and updates weights using an optimization algorithm such as stochastic gradient descent with momentum or an adaptive optimizer. Server may use techniques such as learning-rate scheduling, dropout regularization, and gradient clipping during training to improve generalization and stability. Although training may be performed offline, server stores the resulting trained parameters and uses them during inference-time evaluation.

Server cooperates with an emotion recognition model that has been trained on labeled datasets of facial expressions and vocal signals. For image-based emotion estimation, server uses a convolutional neural network architecture including convolution layers, pooling layers, and fully-connected layers to classify images into emotion categories. For audio-based emotion estimation, server extracts features such as Mel-frequency cepstral coefficients, pitch contours, and energy variations, and inputs these features to a recurrent neural network or transformer-based model. The emotion recognition model is trained using an error function such as categorical cross-entropy, and server stores trained parameters for inference.

Server controls the generative AI model by constructing prompt sentences that not only specify a semantic task but also enforce a structured output format. Server uses templates stored in configuration data to build these prompt sentences. For example, server may use the following prompt sentence:

“Analyze the following answer from a job candidate and evaluate the candidate's problem-solving ability and stress tolerance. Provide the result in the following format: ‘problem_solving_score: [1-10], stress_tolerance_score: [1-10], comment: [short explanation]’. Answer: I am very good at solving complex technical problems under time pressure.”

In another embodiment, server uses a prompt sentence for trait extraction such as: “From the following answer, infer the candidate's main personality traits, including creativity, cooperativeness, and adaptability. Describe each trait in one sentence. Answer: I like to think of new ideas and improve existing processes.”

Server constructs such prompt sentences programmatically, based on question category, current dialogue context, and stored past evaluation results, rather than relying on static, manually written prompts. By embedding explicit format specifications, server causes the generative AI model to output data that can be directly parsed into structured fields, thereby reducing ambiguity and post-processing cost.

Server analyzes the generative AI output by tokenizing the generated text according to the specified format, performing pattern matching or syntax parsing, and validating that each required field is present and within an allowed range. Server converts parsed values into an internal numeric representation such as a vector of floating-point numbers stored in contiguous memory. Server then updates the ability index vector and trait index vector for the current session by applying a combination function, for example a weighted moving average or a rule-based aggregation depending on the question type. Because server uses mathematically defined operations on structured data, the system achieves stable and repeatable behavior, which is difficult to obtain with free-form text alone.

Server fuses emotion estimation results with language-based indices using a fusion algorithm. In one embodiment, server uses a feature-level fusion approach in which server concatenates an ability index vector, a trait index vector, and an emotion feature vector (for example, probabilities for each emotion class and continuous arousal/valence scores) into a joint feature vector. Server then applies a trained linear or non-linear transformation, such as a multilayer perceptron, to map the joint feature vector into an integrated evaluation index and a risk index. This transformation is trained offline on labeled data where ground-truth risk or performance outcomes are known. In another embodiment, server uses a rule-based fusion in which specific emotion patterns, such as a consistent increase of negative affect when discussing responsibility, trigger adjustments to the risk index beyond the baseline derived from text alone.

Server generates report data by filling a document template with computed indices and narrative text. Server uses a template stored as a markup document containing placeholders for ability indices, trait indices, integrated evaluation indices, risk levels, and explanatory text. Server inserts values and explanatory text into the template and then passes the composed markup to a rendering module, which converts the markup into a document format such as a portable document format. Server stores generated document data in a storage device and maintains an index mapping session identifiers to corresponding report files.

Server receives behavior history data and past evaluation results from a storage device when an additional analysis is required. Server detects items that were unclear in previous document screening by identifying indices with low confidence, missing values, or high variance across sessions. Server then constructs an additional prompt sentence designed to improve coverage of these unclear items. For example, server may generate: “Based on the previous interview, the candidate's leadership ability remains unclear. Ask three follow-up questions that specifically probe leadership in challenging situations, and then, after receiving answers, evaluate leadership strength on a scale from 1 to 10 with a brief justification.”

Server forwards such additional prompt sentences to the generative AI model and collects new structured outputs, which server then merges into the existing ability and trait indices. By doing so, server refines internal representations without requiring manual redesign of questionnaires.

Server computes a risk level by comparing integrated evaluation indices and emotion-related patterns against predetermined or dynamically learned thresholds. Server stores threshold values and adjustment rules as configuration data, and may adapt thresholds based on system-wide statistics over time. When the risk index exceeds a threshold or when specific patterns of emotion change occur, server generates warning information including at least a category of warning and a numerical severity value. Server encodes warning information as lightweight data structures for efficient transmission to terminal.

Server transmits to terminal report data references, numerical indices, and warning information. Server encodes such data in structured messages and minimizes payload size by omitting redundant content or compressing large document data. This reduces communication load and improves response times, especially when multiple terminals are concurrently connected.

Terminal implements a user interface on a client device such as a portable computing device or a head-mounted display device. Terminal executes software that displays questions and instructions, collects answer data from keyboard, touchscreen, or microphone, and captures image information from a camera. Terminal encodes these inputs into a predefined data structure with fields for session identifier, question identifier, answer text, and optional audio and video data. Terminal performs local preprocessing such as audio encoding and image compression to reduce bandwidth, and then transmits data to server via a network.

Terminal receives from server structured evaluation indices, risk levels, and links or identifiers for report data. Terminal renders key indices on its display, for example as numerical scores or graphical indicators. When warning information is received, terminal presents a visual or auditory notification, such as a colored icon, a banner, or a speech output. In the case of a head-mounted display device, terminal overlays warning symbols onto a user's field of view to support real-time monitoring in physical environments.

User interacts with terminal to start or end an evaluation session, to answer questions, and to review evaluation results. User may select different evaluation modes, such as recruitment assessment or security screening, which cause server to load corresponding rule sets and prompt templates. User may also request follow-up analyses; in response, terminal sends control instructions to server, and server generates new prompt sentences and updates indices accordingly.

This system improves computer technology beyond mere automation of human evaluation. Because server enforces structured output formats via prompt sentences and uses explicit data structures for indices and emotion features, the system reduces ambiguity in natural language outputs and enables efficient machine-level aggregation and comparison across sessions. The structured design of prompt sentences also reduces the need for repeated inference cycles and manual correction, thereby lowering computational load and latency.

Furthermore, server uses a multi-modal fusion algorithm that integrates linguistic features from the generative AI model and emotion features from the emotion recognition model. This integration is implemented as a concrete function over numeric vectors, trained with explicit error minimization on labeled data, rather than as an informal human-interpreted combination. As a result, the system achieves higher prediction accuracy and more stable risk estimation than systems that treat text and emotion streams separately. The causal relationship between fusion and improved performance can be verified by comparing error metrics on validation datasets with and without fusion.

The use of accelerators and batch processing of inference tasks allows server to handle many sessions in parallel while maintaining response time within a bound suitable for real-time decision support. Server can group requests from multiple terminals into batches for the generative AI model and emotion recognition model, thereby improving computational efficiency and reducing energy consumption per evaluation. By caching intermediate representations, such as tokenized dialogue content and feature vectors, server avoids redundant computation when refining or reusing analyses.

The internal architecture of the generative AI model and emotion recognition model is exploited in a non-conventional manner. Instead of simply generating free-form text explanations, server uses the generative AI model as a configurable function from structured prompt sentences to structured outputs, controlled tightly by format specifying information. Server thereby repurposes the language model from a purely human-oriented generator into a machine-oriented component in a larger computation pipeline. This non-traditional usage enables automatic computation of indices and risk levels from unstructured dialogue, which would be difficult to perform reliably using rule-based systems alone.

In another embodiment, server uses an alternative generative model architecture, such as a sequence-to-sequence recurrent network, and an alternative fusion method, such as a probabilistic graphical model that combines trait indices and emotion states into a joint risk distribution. In another variation, server stores dialogue content and indices in a graph database, linking traits, sessions, and emotional events as nodes and edges, and runs graph algorithms to detect anomalous patterns indicative of risk. These variations still maintain the core concept of generating structured indices through prompt-controlled generative AI and integrating them with emotion-based measurements under unified server control.

In yet another embodiment, server executes the generative AI model locally rather than via a remote service. Server loads model parameters into memory and performs inference calls through a local inference engine. This configuration further reduces network latency and allows deeper integration between the inference engine and the fusion module, such as sharing memory buffers for feature vectors between components.

By configuring server, terminal, and user interactions in the manner described, the system provides a concrete technical solution in which generative AI and emotion recognition models are orchestrated through specific data structures, algorithms, and prompt sentence strategies. This solution yields improved accuracy, speed, and robustness of automated evaluation and risk assessment, and enhances the functioning of the underlying computer system beyond a simple implementation of a business process.

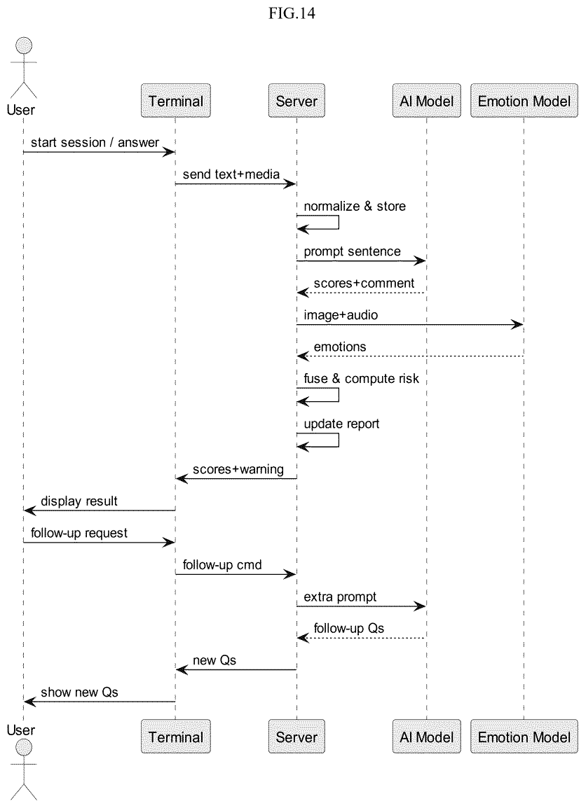

The following describes the processing flow using FIG. 14.

### Step 1:

User operates the terminal to start an evaluation session.

User selects an evaluation mode (for example, recruitment interview or security screening) on the terminal and confirms a predetermined theme.

Input: User selection (mode, theme).

Output: Session configuration data (mode identifier, theme identifier) stored on terminal and sent to server.

Terminal packages the session configuration into a structured message and transmits it to server over a secure network connection.

### Step 2:

Terminal presents questions and collects answer data and biometric information.

Terminal displays a question related to the predetermined theme on a screen and optionally outputs audio guidance.

User inputs an answer by typing text or speaking into a microphone, and terminal optionally captures facial images via a camera.

Input: User's raw text input, speech signal, and image frames.

Output: Normalized answer text, encoded audio data, and compressed image data.

Terminal converts speech to text using a local or remote speech recognizer, encodes audio into a standard format, compresses images to a defined resolution, and stores the results in a local buffer.

### Step 3:

Terminal sends multi-modal data to server.

Terminal creates a structured request that includes a session identifier, question identifier, normalized answer text, encoded audio, and compressed image frames.

Input: Normalized text, encoded audio, compressed images, session configuration.

Output: Network request containing a JSON or equivalent data structure.

Terminal transmits the request to server using a communication protocol such as HTTPS and waits for a response.

### Step 4:

Server receives and normalizes the input data.

Server reads the incoming request, decodes the structured data, and verifies required fields such as session identifier, answer text, and timestamps.

Input: Network request from terminal.

Output: Normalized internal records for dialogue content and biometric streams.

Server converts character encodings to a unified format, resamples audio to a standard sampling rate, resizes images to the required dimensions for the emotion recognition model, and stores normalized records in persistent storage.

### Step 5:

Server updates the dialogue state and stores a dialogue turn.

Server associates the received answer with the current session and appends a new dialogue turn record containing speaker identifier, text string, and timestamp.

Input: Normalized answer text and session identifier.

Output: Updated dialogue history object stored in memory and optionally persisted in storage.

Server computes a turn index and links the dialogue turn to references of the associated audio and image data.

### Step 6:

Server constructs a context-aware prompt sentence for the generative AI model.

Server reads the current dialogue history, the question category, and any past evaluation results to determine which analysis template to apply.

Input: Dialogue history, session configuration, template rules.

Output: A concrete prompt sentence specifying analysis task and output format.

Server fills placeholders in a template with the user's answer and contextual information. For example, server may generate: “Analyze the following answer from a job candidate and evaluate the candidate's problem-solving ability and stress tolerance. Provide the result in the following format: ‘problem_solving_score: [1-10], stress_tolerance_score: [1-10], comment: [short explanation]’. Answer: I am very good at solving complex technical problems under time pressure.”

### Step 7:

Server submits the prompt sentence to the generative AI model and performs inference.

Server packages the prompt sentence into a model-specific request and sends it either to a local inference engine or to a remote inference service.

Input: Prompt sentence and model configuration parameters (for example, temperature, max tokens).

Output: Generated text conforming to the requested format.

Server invokes the generative AI model, which processes the tokenized prompt through its neural network layers and returns a generated response. Server receives this response as text.

### Step 8:

Server parses and validates the generative AI output.

Server inspects the generated text and extracts fields specified in the prompt sentence, such as scores and comments.

Input: Generated text from the generative AI model.

Output: Structured data containing ability indices, trait indices, and explanatory comments.

Server uses pattern matching or a lightweight parser to locate key labels, converts score strings to numeric values, checks that each score is within allowed bounds, and records any parsing errors for possible re-prompting.

### Step 9:

Server performs emotion recognition on the biometric information.

Server forwards the normalized image frames to an image-based emotion recognition model and audio features to an audio-based emotion recognition model.

Input: Normalized images and audio features linked to the answer.

Output: Emotion probabilities per class and continuous measures such as arousal and valence over time.

Server runs convolutional or similar operations to classify facial expressions, computes audio features such as pitch and energy, and infers emotion categories and intensities. Server stores emotion observations with timestamps.

### Step 10:

Server aligns emotion observations with the dialogue turn.

Server synchronizes emotion timestamps with the time interval of the answer and derives summary emotion features for that interval.

Input: Emotion observations (time-stamped) and dialogue turn timestamps.

Output: Aggregated emotion feature vector for the current answer.

Server aggregates probabilities across the time window by computing averages, maxima, or other statistics and attaches the resulting feature vector to the dialogue turn record.

### Step 11:

Server computes integrated evaluation indices and a risk index.

Server combines structured output from the generative AI model (ability indices and trait indices) with the aggregated emotion features.

Input: Ability index vector, trait index vector, emotion feature vector.

Output: Integrated evaluation index and risk index values.

Server concatenates or otherwise merges vectors and applies a fusion function, such as a trained multilayer perceptron or a rule-based mapping, to compute an overall evaluation and a risk level. Server writes these indices back into the session object and persists them in storage.

### Step 12:

Server generates or updates report data.

Server retrieves or initializes a report template for the current session and fills placeholders with updated indices, comments, and emotion summaries.

Input: Integrated evaluation index, risk index, explanatory text, report template.

Output: Updated report data represented in a markup or structured document description.

Server inserts numeric values and narrative explanations into the template, updates sections corresponding to new answers, and stores the intermediate representation for later rendering.

### Step 13:

Server computes warning information based on the risk index.

Server compares the risk index and associated patterns of emotion change with predetermined thresholds and rules.

Input: Risk index and emotion trend data.

Output: Warning information including warning category and severity, or an indication that no warning is needed.

Server applies conditional logic to determine whether the risk exceeds configured limits and, if so, creates a compact warning record containing type, severity, and a short justification.

### Step 14:

Server prepares a response message for terminal.

Server collects key indices, comments, and any warning information for the current answer and optionally includes a reference to the full report.

Input: Structured indices, warning record, report identifier.

Output: Response payload encoded in a structured message for transmission.

Server serializes the data into a compact format, omitting redundant fields to reduce size, and queues the message for sending via the network interface.

### Step 15:

Terminal receives and displays evaluation results.

Terminal obtains the response message from server, decodes the structured data, and updates its user interface.

Input: Response payload from server.

Output: Visual or auditory representation of scores, comments, and warnings.

Terminal displays values such as “problem_solving_score: 9” and “stress_tolerance_score: 8,” shows the associated comment text, renders any warning indicator, and presents a control for viewing or downloading the full report.

### Step 16:

User reviews the results and optionally initiates follow-up analysis.

User examines displayed scores and comments on the terminal and may decide that a particular trait remains unclear.

Input: Visualized evaluation results.

Output: User instruction for follow-up, such as a request to probe leadership or integrity.

User activates a follow-up function on the terminal, and terminal sends a control command to server.

### Step 17:

Server generates an additional prompt sentence for deeper analysis.

Server interprets the follow-up command, inspects past evaluation results for the session, and identifies indices with low confidence or missing coverage.

Input: Follow-up command, past evaluation indices, dialogue history.

Output: Additional prompt sentence targeting specific unclear traits.

Server forms a new prompt sentence such as: “Based on the previous conversation, generate three follow-up questions that further assess the candidate's leadership and ethical decision-making.”

Server then forwards this prompt sentence to the generative AI model, and the processing cycle can repeat from the point of presenting new questions to user.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

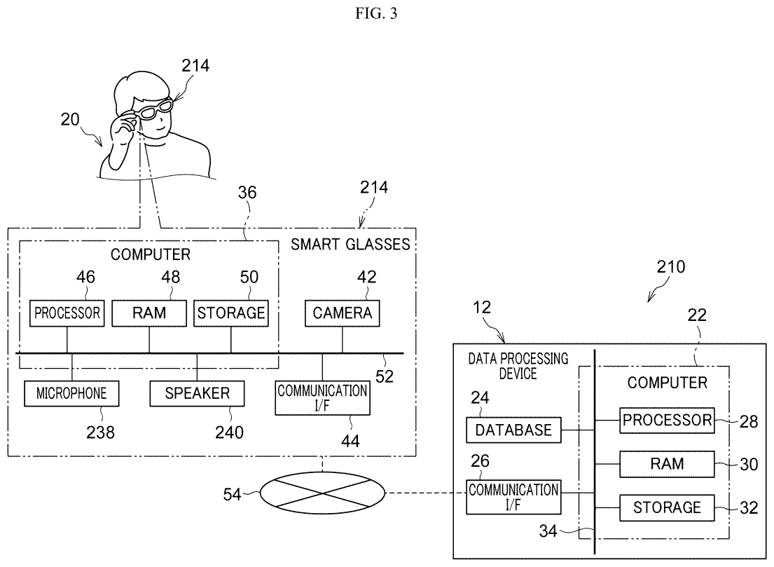

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

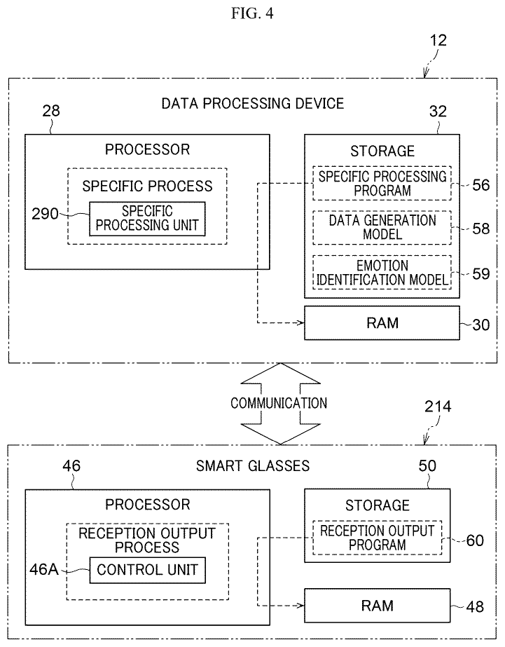

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

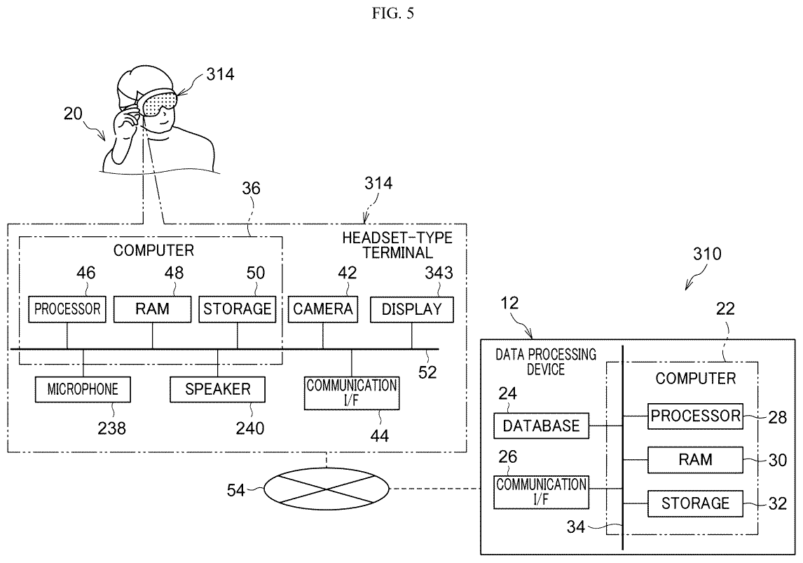

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

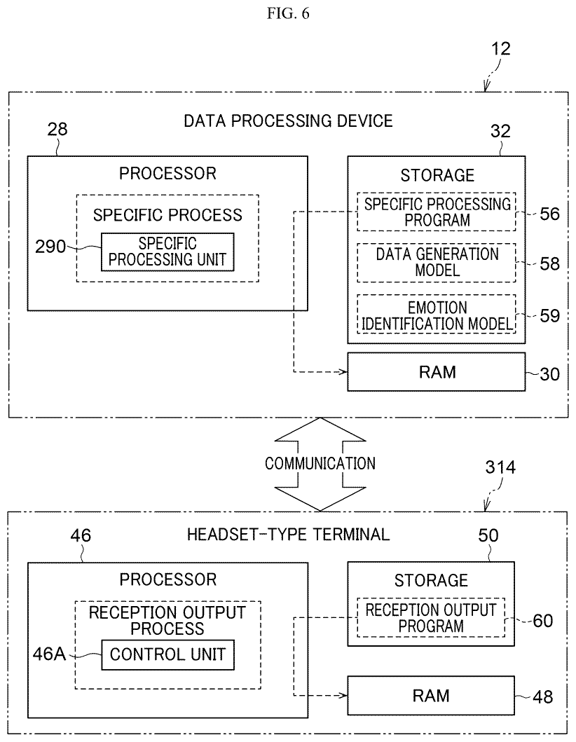

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

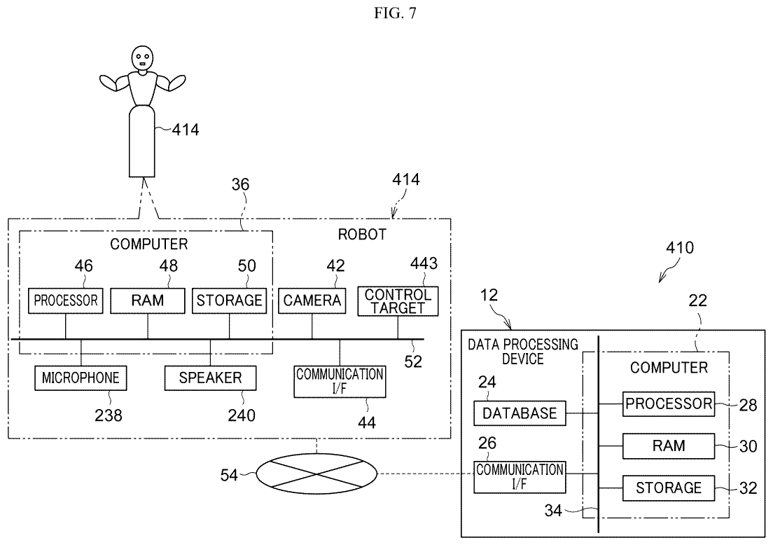

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

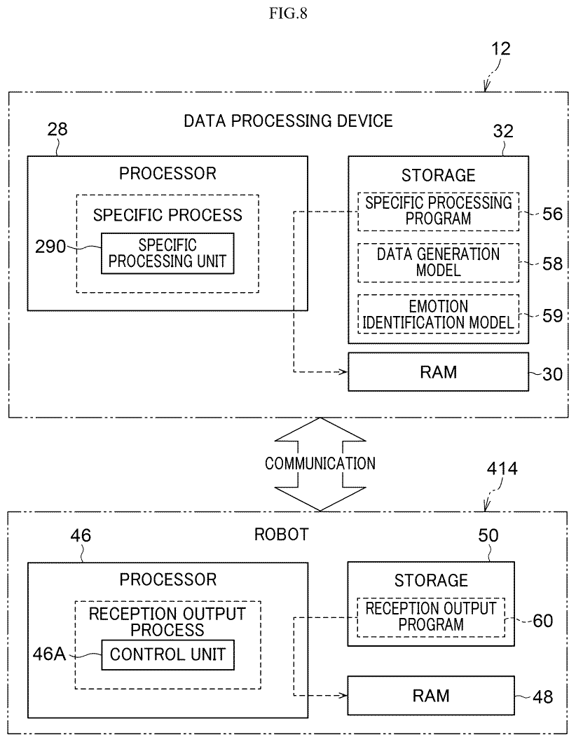

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

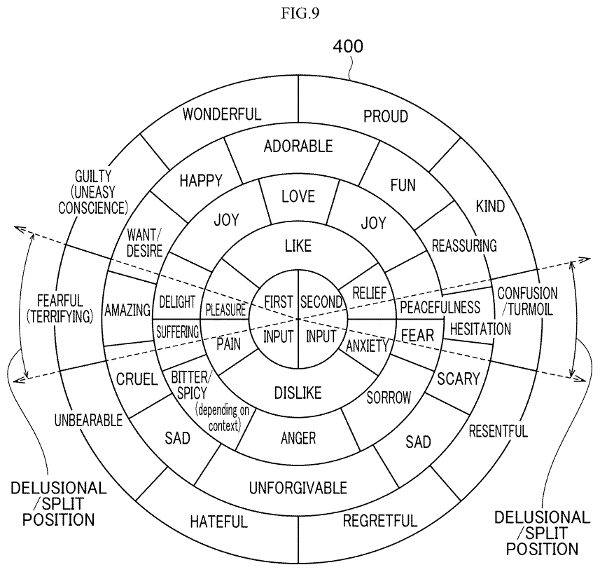

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

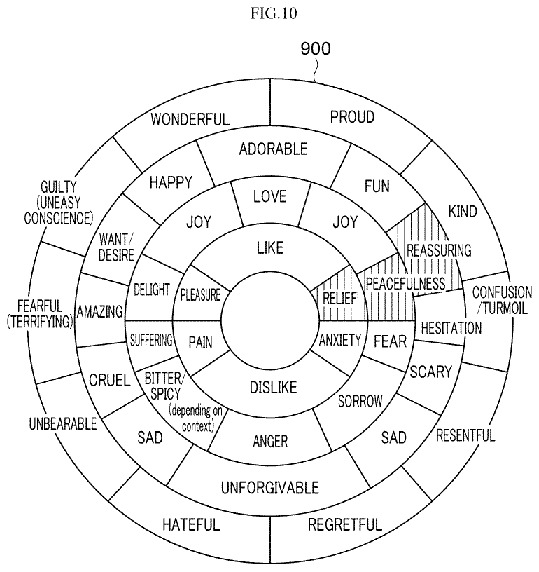

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
acquire user identification information from a terminal device, compare the user identification information with authentication information stored in a storage device, perform user authentication based on a comparison result, and generate a user session for dialogue processing based on an authentication result,
retrieve a plurality of topic candidates associated with the user session from the storage device, present the topic candidates as selectable items for dialogue to the terminal device, and acquire topic information selected through the terminal device,
generate an initial prompt sentence, for input to a generative AI model that performs interactive information processing, based on the selected topic information, transmit a dialogue start request including the initial prompt sentence to the generative AI model, acquire a first question sentence from the generative AI model, and store the first question sentence as part of a dialogue history while presenting the first question sentence to the terminal device,
receive, from the terminal device, user utterance data including a response sentence to the first question sentence, sequentially store the user utterance data in the dialogue history, convert the dialogue history into an input data format for the generative AI model, transmit the converted dialogue history to the generative AI model, acquire, from the generative AI model, a follow-up question sentence for additional input, store the follow-up question sentence in the dialogue history, and sequentially present the follow-up question sentence to the terminal device to perform repeated dialogue control,
generate an analysis prompt sentence for extracting evaluation information indicating personality characteristics and thought patterns of the user by performing language analysis processing on the user utterance data included in the dialogue history, and input the analysis prompt sentence and the dialogue history into the generative AI model to acquire an analysis result from the generative AI model,
associate the dialogue history including the user utterance data with an emotion recognition function that executes an emotion estimation process based on expression data and voice data of the user to estimate an emotional state, acquire an emotion estimation result from the emotion recognition function, integrate the emotion estimation result with the analysis result from the generative AI model, and generate evaluation information that evaluates characteristics and emotional aspects of the user, and
generate an evaluation report document used for supporting recruitment activities based on the evaluation information and the dialogue history, and output the evaluation report document as document data.

### (Supplementary 2)

The system according to supplementary 1,
wherein the processor is configured to
retrieve selection information indicating evaluation items that could not be grasped at a document screening stage from the storage device, automatically generate an additional analysis prompt sentence that requests additional analysis from the generative AI model based on the selection information and the dialogue history, transmit the additional analysis prompt sentence to the generative AI model, acquire an additional analysis result from the generative AI model, and append the additional analysis result to the evaluation report document.

### (Supplementary 3)

The system according to supplementary 1,
wherein the processor is configured to
perform a scoring process that maps the analysis result output by the generative AI model, based on the analysis prompt sentence and the additional analysis prompt sentence, to a predetermined evaluation scale, and use a result of the scoring process to quantitatively indicate, in the evaluation report document, characteristic evaluation items and risk evaluation items of the user.

### Application Example 1

### (Supplementary 1)

A system comprising a processor,
wherein the processor is configured to
manage a dialogue between a user and a generative AI model based on a predetermined theme, and acquire dialogue content of the dialogue, and
convert speech information and acoustic feature information of the user, which are obtained via an image information acquisition device and an audio information acquisition device, into character information by using a speech recognition processing device, and generate dialogue history information including the character information, and
generate a prompt sentence based on the dialogue history information and the predetermined theme, and transmit the prompt sentence and the dialogue history information to the generative AI model, and acquire an analysis result in which demand information and preference information of the user or a dialogue partner are estimated, and
search a plurality of candidate information items from at least one of a merchandise information storage device and a service information storage device based on the analysis result, and select and rank the candidate information items according to a degree of relevance to the demand information and the preference information, and
format the selected and ranked candidate information items into display information that is displayable in real time on a visual display device, and present the display information to the user as an assistance tool for customer service activities, and
generate report information including at least a persona, a characteristic, the demand information, and the preference information of the dialogue partner based on the dialogue history information and the analysis result, and store the report information in a storage device, and
output the stored report information in a form referable in customer service activities performed at a later time.
   (supplementary 2)

The system according to Supplementary 1,
wherein the processor is configured to
generate the prompt sentence by extracting speech information within a predetermined period from the dialogue history information, extracting phrases related to the demand information and the preference information of the dialogue partner from the speech information, and including a description that emphasizes the extracted phrases so as to improve estimation accuracy of the demand information and the preference information by the generative AI model.

### (Supplementary 3)

The system according to Supplementary 1,
wherein the processor is configured to
generate the prompt sentence by including a description that instructs creation of the report information, request the generative AI model to create, based on an entirety of the dialogue history information, at least a summary of the persona of the dialogue partner, an estimation of a lifestyle, an estimation of a purchasing tendency, and a recommended response policy at a next customer service opportunity, and store, in the storage device, the report information generated by the generative AI model in response to the request.

### EXAMPLE 2

### (Supplementary 1)

A system comprising a processor,
wherein the processor is configured to
collect response information from an examinee regarding a predetermined task through an information input device, and store the response information in a storage device,
perform preprocessing on the response information stored in the storage device, the preprocessing including at least character normalization, removal of unnecessary whitespace and control characters, and segmentation into sentences and words, and convert the response information into a format that is analyzable by a generative processing engine,
generate, together with the preprocessed response information, a prompt sentence written in a natural language that defines an evaluation policy for at least one of an ability or a characteristic of the examinee, and transmit the prompt sentence to the generative processing engine,
convert an analysis result obtained from the generative processing engine into structured evaluation data, and store, in the storage device, evaluation information for each examinee including at least an ability index, a behavioral characteristic, and a text portion serving as supporting evidence,
aggregate the evaluation information, generate a report document regarding a characteristic and a latent ability of the examinee, and format the report document as display data outputtable to a display device, and
acquire an evaluation result or feedback information from a user regarding the report document, and update at least one of contents of the prompt sentence or the evaluation policy dynamically based on the feedback information.

### (Supplementary 2)

The system according to supplementary 1,
wherein the processor is configured to
specify, in generating the prompt sentence, at least one of problem-solving ability, collaborative behavior, leadership behavior, and communication style of the examinee, which could not be identified in document screening, as a target of evaluation, generate separate prompt sentences for respective evaluation targets, and transmit a plurality of types of analysis requests to the generative processing engine.

### (Supplementary 3)

The system according to supplementary 1,
wherein the processor is configured to
verify whether the analysis result returned from the generative processing engine conforms to a predetermined format or a predetermined value range, and, based on a verification result, reflect the analysis result in the report document as an evaluation record including at least a numerical evaluation item, a classification label, and explanatory text.

### Application Example 2

### (Supplementary 1)

A system comprising a processor,
wherein the processor is configured to
conduct a dialogue between an evaluation target and a generative AI model regarding a predetermined theme, and analyze a content of the dialogue using the generative AI model,
acquire speech information and image information of the evaluation target, and estimate an emotional state and a temporal change of the emotional state of the evaluation target by analyzing the speech information and the image information using an emotion recognition model,
numerically calculate an ability index and a trait index of the evaluation target based on an analysis result of the dialogue content by the generative AI model, and compute an integrated evaluation index by associating the ability index and the trait index with the emotional state and the temporal change of the emotional state estimated by the emotion recognition model,
generate report data including descriptive information relating to traits, abilities, and emotional aspects of the evaluation target, based on the integrated evaluation index, by applying a document template, and output the report data as document data,
receive, from a terminal device, answer data, behavior history data, or biometric information data, dynamically generate a prompt sentence for input to the generative AI model based on the received data, and transmit the prompt sentence together with the received data to the generative AI model,
calculate a risk level according to a predetermined threshold based on an analysis result output from the generative AI model and an emotion estimation result output from the emotion recognition model, and generate warning information corresponding to the risk level, and transmit the report data and the warning information to the terminal device in real time, and convert the report data and the warning information into a presentation format that is visually or auditorily presentable on the terminal device.

### (Supplementary 2)

The system according to supplementary 1,
wherein the processor is configured to
acquire, from a storage device, a plurality of pieces of answer data transmitted from the terminal device and past evaluation results, generate an additional prompt sentence for causing the generative AI model to analyze interrelationships among the plurality of pieces of answer data and consistency with the past evaluation results, transmit the additional prompt sentence to the generative AI model, cause the generative AI model to perform a detailed analysis of trait items of the evaluation target that were unclear from document information, and reflect an analysis result of the detailed analysis in the report data and in calculation of the risk level.

### (Supplementary 3)

The system according to supplementary 1,
wherein the processor is configured to
include format specifying information in the prompt sentence so as to cause the generative AI model to output structured data, parse text output obtained from the generative AI model into structured data including evaluation indices, explanatory text, and supporting information, and automatically calculate an ability index, a trait index, and a risk index based on the structured data and reflect the ability index, the trait index, and the risk index in the report data.

What is claimed is:

1. A system comprising:
circuitry configured to:
acquire, via a communication interface coupled to a packet-switched network, topic selection data from a terminal device, retrieve a topic description from an information storage device based on the topic selection data, and construct an initial instruction sequence comprising the topic description and a dialogue policy parameter, and input the initial instruction sequence into a generative neural network model comprising a transformer-based architecture to acquire an initial query output;
transmit the initial query output to the terminal device via the communication interface, acquire response data from the terminal device, store the response data in the information storage device in association with a session identifier and a timestamp, construct a context sequence comprising prior dialogue records and a control instruction, and input the context sequence into the generative neural network model to acquire a follow-up query output, and repeat the acquiring, storing, and constructing until a termination condition is satisfied to produce a dialogue transcript;
acquire multimodal signal data from the terminal device during the dialogue, the multimodal signal data comprising image frame data and audio segment data, preprocess the image frame data by executing a face region extraction operation and a spatial normalization operation, preprocess the audio segment data by computing spectral feature representations, and input the preprocessed image frame data and the spectral feature representations into respective neural network models to compute emotion estimation data comprising probability distributions over a plurality of affective state categories;
construct an analysis instruction sequence comprising the dialogue transcript and the emotion estimation data, input the analysis instruction sequence into the generative neural network model, and acquire analysis output data comprising attribute descriptors and behavioral pattern classifications;
compute a composite assessment score by applying a weighted integration operation to the analysis output data and the emotion estimation data, and generate structured assessment output data comprising the composite assessment score, summary text, and supporting evidence references; and
store the structured assessment output data in the information storage device and transmit the structured assessment output data to the terminal device via the communication interface.

2. The system according to claim 1,
wherein the circuitry is further configured to acquire supplemental query data identifying evaluation items not addressed in the dialogue transcript, construct a supplemental analysis instruction sequence referencing specific portions of the dialogue transcript corresponding to the evaluation items, input the supplemental analysis instruction sequence into the generative neural network model, and update the structured assessment output data based on supplemental analysis output data acquired from the generative neural network model.

3. The system according to claim 2,
wherein the supplemental query data is derived from document screening data stored in the information storage device, and the circuitry generates the supplemental analysis instruction sequence using rule-based templates that map screening items to analytical questions.

4. The system according to claim 1,
wherein the emotion estimation data is temporally aligned with specific dialogue turns by associating each emotion probability distribution with a time interval corresponding to a dialogue record in the dialogue transcript.

5. The system according to claim 4,
wherein the circuitry is further configured to identify dialogue turns in which the emotion estimation data indicates a change in affective state exceeding a predetermined threshold, and to annotate the corresponding dialogue records with an affective state change flag.

6. The system according to claim 1,
wherein the spectral feature representations comprise at least mel-frequency cepstral coefficients, fundamental frequency contour values, and energy envelope values extracted from the audio segment data.

7. The system according to claim 1,
wherein the face region extraction operation comprises detecting a face bounding box in each image frame using a convolutional neural network, cropping the image frame to the detected bounding box, and resizing the cropped region to a predetermined spatial resolution.

8. The system according to claim 1,
wherein the weighted integration operation comprises assigning weighting coefficients to individual attribute descriptors from the analysis output data and individual affective state categories from the emotion estimation data, multiplying each attribute descriptor score and affective state score by the corresponding weighting coefficient, and summing the weighted scores to produce the composite assessment score.

9. The system according to claim 8,
wherein the circuitry is further configured to normalize the composite assessment score to a predetermined scale, and to classify the normalized composite assessment score into a rating category based on stored threshold values.

10. The system according to claim 1,
wherein the termination condition comprises at least one of a maximum number of dialogue turns being reached, an elapsed time exceeding a time limit parameter, or a termination signal being received from the terminal device.

11. The system according to claim 1,
wherein the dialogue policy parameter specifies at least one of a conversational topic focus, a maximum response length, or an instruction directing the generative neural network model to generate open-ended interrogative outputs.

12. The system according to claim 1,
wherein the circuitry is further configured to, upon receiving user feedback data from the terminal device regarding the structured assessment output data, update at least one of the dialogue policy parameter, the weighting coefficients of the weighted integration operation, or the analysis instruction sequence based on the user feedback data.

13. The system according to claim 12,
wherein the update based on user feedback data comprises adjusting the weighting coefficients to increase emphasis on attribute descriptors that were modified or flagged by the user feedback data.

14. The system according to claim 1,
wherein the circuitry is further configured to convert the dialogue transcript into a tokenized input by applying a tokenizer compatible with the generative neural network model, and when a token count of the tokenized input exceeds a context length threshold, to truncate or segment the tokenized input based on dialogue turn boundaries.

15. The system according to claim 1,
wherein the structured assessment output data further comprises a formatted document generated by filling a report template with the composite assessment score, the summary text, and selected excerpts from the dialogue transcript.

16. The system according to claim 15,
wherein the report template comprises predefined sections for attribute evaluation scores, behavioral pattern descriptions, affective state analysis results, and supporting dialogue excerpts.

17. The system according to claim 1,
wherein the dialogue relates to a recruitment evaluation of a candidate, and the structured assessment output data comprises an interview assessment report evaluating characteristics and emotional aspects of the candidate.

18. A system comprising:
circuitry configured to:
manage a dialogue session with an entity via a terminal device coupled to a packet-switched network by iteratively constructing instruction sequences based on accumulated dialogue records and inputting the instruction sequences into a generative neural network model comprising a transformer-based architecture to acquire generated query outputs, and storing the generated query outputs and response data in an information storage device;
acquire multimodal signal data from the terminal device during the dialogue session, extract feature representations from the multimodal signal data using neural network models, and compute affective state classification data based on the extracted feature representations;
construct an analysis instruction sequence based on the accumulated dialogue records and the affective state classification data, input the analysis instruction sequence into the generative neural network model, and acquire analysis output data; and
generate structured assessment output data by integrating the analysis output data and the affective state classification data using a weighted scoring operation, and transmit the structured assessment output data to the terminal device via the communication interface.

19. The system according to claim 18,
wherein the circuitry is further configured to acquire supplemental evaluation criteria, construct a supplemental analysis instruction sequence referencing the accumulated dialogue records and the supplemental evaluation criteria, and update the structured assessment output data based on supplemental analysis results from the generative neural network model.

20. A system comprising:
circuitry configured to:
conduct a multi-turn dialogue with a terminal device via a communication interface coupled to a packet-switched network by iteratively generating query outputs using a generative neural network model and accumulating response data to produce a dialogue transcript;
acquire multimodal signal data during the dialogue, compute affective state data by processing the multimodal signal data through neural network classifiers, and temporally align the affective state data with dialogue turns in the dialogue transcript;
input the dialogue transcript and the affective state data into the generative neural network model to acquire attribute analysis data; and
generate assessment output data by computing a composite score from the attribute analysis data and the affective state data, and transmit the assessment output data to the terminal device.
